(19) United States
(12) Patent Application Publication
(10) Pub. No.: US 2025/0075439 A1
(43) Pub. Date: Mar. 6, 2025

(54) A SWITCH FOR VEHICLES

(71) Applicant: HYPERLOOP TECHNOLOGIES, INC., Dubai (AE)

(72) Inventors: Tim LAMBERT, Los Angeles, CA (US); Niedziela KORNEL, Beverly Hills, CA (US)

(21) Appl. No.: 18/723,832

(22) PCT Filed: Dec. 22, 2022
(86) PCT No.: PCT/US2022/053789

§ 371 Date: Jun. 24, 2024

Related U.S. Application Data
(60) Provisional application No. 63/293,670, filed on Dec. 24, 2021.
(60) Provisional application No. 63/293,674, filed on Dec. 24, 2021.
(60) Provisional application No. 63/293,677, filed on Dec. 24, 2021.
(60) Provisional application No. 63/293,681, filed on Dec. 24, 2021.

(51) Int. Cl. E01B 25/34; B60L 13/04

(52) U.S. Cl. CPC E01B 25/34; B60L 13/04

(57) ABSTRACT

A switch for vehicles is provided. In particular, a switch for a levitation rail for a vehicle is provided. The switch comprises: a straight rail; a curved rail, curving away from the straight rail, the straight rail and the curved rail comprising magnetic material to magnetically interact with a motor of the vehicle; and a magnetic gap between the straight rail and the curved rail, the magnetic gap comprising a region, at which the straight rail and the curved rail meet, of lower magnetic permeability relative to the straight rail and the curved rail.

### CROSS-REFERENCE TO RELATED APPLICATIONS

The present application claims priority from U.S. Patent Application No. 63/293,670, filed on Dec. 24, 2021, and from U.S. Patent Application No. 63/293,674, filed on Dec. 24, 2021, and from U.S. Patent Application No. 63/293,677 filed on Dec. 24, 2021, and from U.S. Patent Application No. 63/293,681, filed on Dec. 24, 2021, the contents of all of which are incorporated herein by reference.

### BACKGROUND

The constraints of a transportation system that seeks to promote high speed, high efficiency, and high power density, impose challenges that are not present in the state of the art. In particular, switching payloads and/or vehicles between tracks may be challenging.

### BRIEF DESCRIPTIONS OF THE DRAWINGS

For a better understanding of the various examples described herein and to show more clearly how they may be carried into effect, reference will now be made, by way of example only, to the accompanying drawings in which:

FIG. 1 depicts a view of a high-speed transport system that includes a track and track segments, various rails, and a vehicle configured to move along the track and rails, according to non-limiting examples.

FIG. 2A depicts a perspective view of a homopolar linear synchronous machine, according to non-limiting examples.

FIG. 2B depicts a side view of the homopolar linear synchronous machine, according to non-limiting examples.

FIG. 3 depicts top view of a switch for the high-speed transport system of FIG. 1, according to non-limiting examples.

FIG. 4A depicts a top view of details of the switch of FIG. 3, as a vehicle approaches a curved portion along a straight portion, according to non-limiting examples.

FIG. 4B depicts a perspective view of details of the switch of FIG. 3, as the vehicle approaches the curved portion along the straight portion, according to non-limiting examples.

FIG. 5A depicts an example of a magnetic gap between a straight rail and a curved rail of the switch of FIG. 1, the magnetic gap comprising an airgap, according to non-limiting examples.

FIG. 5B depicts an example of a magnetic gap between the straight rail and the curved rail of the switch of FIG. 1, the magnetic gap comprising a non-magnetic material, according to non-limiting examples.

FIG. 5C depicts an example of a magnetic gap between the straight rail (e.g. of the straight portion) and the curved rail (e.g. of the curved portion) of the switch of FIG. 1, the magnetic gap comprising a slot or a groove, according to non-limiting examples.

FIG. 6A depicts a top view of further details of the switch of FIG. 3, as the vehicle approaches the curved rail along the straight rail, according to non-limiting examples.

FIG. 6B depicts an end view of details of FIG. 6A, showing a relative position of levitation actuators of the vehicle to the straight rail, according to non-limiting examples.

FIG. 6C depicts details of FIG. 6B, showing magnetic flux between the levitation actuators of the vehicle and the straight rail, according to non-limiting examples.

FIG. 7A depicts a top view of further details of the switch of FIG. 3, as the vehicle is at the intersection between the curved rail and the straight rail, according to non-limiting examples.

FIG. 7B depicts an end view of details of FIG. 6A, showing a relative position of levitation actuators of the vehicle to the straight rail, the curved rail and the magnetic gap therebetween, according to non-limiting examples.

FIG. 7C depicts details of FIG. 6B, showing magnetic flux between the levitation actuators of the vehicle and the straight rail, and position of the magnetic flux relative to the magnetic gap, according to non-limiting examples.

FIG. 8 depicts a top view of the straight rail, the curved rail, and the magnetic gap relative to the levitation actuators of the vehicle, to show area of the magnetic gap relative to area of the levitation actuators, as the vehicle switches to the curved rail, according to non-limiting examples.

FIG. 9A depicts a top view of walls of the switch, track segments of the switch, the straight rail, the curved rail and the magnetic gap, all relative to the vehicle, as the vehicle switches to the curved rail, according to non-limiting examples.

FIG. 9B depicts an end view of a portion of walls of the switch relative to the vehicle, according to non-limiting examples.

FIG. 10 depicts a top view of the straight rail, the curved rail, and the magnetic gap relative to the levitation actuators and guidance actuators of the vehicle, as the vehicle switches to the curved rail, as well as forces between the levitation actuators, the curved rail and the straight rail, and forces between the guidance actuators and a guidance rail, according to non-limiting examples.

FIG. 11 shows a vehicle comprised of a vehicle chassis and a guidance system with four guidance skis, wherein each guidance ski is comprised of four electromagnetic actuators; the skis may be pivoted with respect to the vehicle.

FIG. 12 shows a vehicle comprised of a vehicle chassis and a guidance system with four guidance skis, wherein each guidance ski is comprised of four electromagnetic actuators. The skis are fixed with respect to the vehicle.

FIG. 13 shows a vehicle comprised of a vehicle chassis and a guidance system with four guidance skis, wherein the track is curved, but the guidance skis are not tangent to the track.

FIG. 14 shows a vehicle comprised of a vehicle chassis and a guidance system with four guidance skis, where the track is curved, and the angled electromagnetic actuators are tangent to the track.

FIG. 15 shows a vehicle comprised of a guidance system with four guidance skis, wherein the forced produced by the electromagnetic actuators are show in exemplary amplitudes in a manner consistent with their reaction to a curved track.

FIG. 16 shows a vehicle comprised of a vehicle chassis and a guidance system with four guidance skis, where the track is flat, and the sequence of actuators are tangent to the track.

FIG. 17 shows a vehicle comprised of a guidance system with four guidance skis, wherein the forced produced by the electromagnetic actuators are show in exemplary amplitudes in a manner consistent with their reaction to a flat track.

FIG. 18A depicts two electromagnetic actuators on a guidance ski, wherein the guidance ski is tangent to the track at the location defined by the intersection of the plane of the angled actuator and the other actuators on the ski.

FIG. 18B depicts two electromagnetic actuators on a guidance ski, wherein the guidance ski is tangent to the track along the entire surface of the sequence of actuators with the exception of the angled actuator.

FIG. 19 depicts a vehicle comprised of a vehicle chassis and a guidance system with four guidance skis, and shows the action distance between two skis and their tangent locations to the track; FIG. 19 also shows an approximate location of a “back-guidance” force produced by the outboard guidance actuators.

FIG. 20 depicts the change in force authority which occurs when an electromagnetic actuator is present on variable track curvature, and shows the relationship between the force authority of the angled engine to the force authority of the plurality of coplanar electromagnetic actuators.

### DETAILED DESCRIPTION

The constraints of a transportation system that seeks to promote high speed, high efficiency, and high power density, impose challenges that are not present in the state of the art. In particular, switching payloads and/or vehicles between tracks may be challenging.

In particular the transportation system may include various tracks and/or rails for various types of magnetically based motors and/or engines and/or actuators of vehicles. For example, the transportation system may include a propulsion track to propel a payload and/or a vehicle along the propulsion track using one or more propulsion motors of the vehicle (e.g. a propulsion motor and the track forming a homopolar linear synchronous machine). The transportation system may further include a levitation track and/or rail to levitate the payload and/or the vehicle and/or the propulsion motor(s) relative to the propulsion track using one or more levitation actuators of the vehicle interacting with the levitation track and/or rail. The transportation system may further include a guidance track and/or rail to laterally guide the payload and/or a vehicle and/or the propulsion motor(s) relative to the propulsion track using one or more guidance actuators of the vehicle interacting with the guidance track and/or rail.

Switching the payload and/or the vehicle and/or the propulsion motor(s) from one track and/or rail to another track and/or rail may be challenging. In particular, propulsion motors, guidance actuators and levitation actuators may be attached to a payload to form a vehicle, and respective tracks and/or rails may be attached to walls or reciprocal surfaces of the transportation system. Track segments which form a propulsion track may be attached to opposing walls of the transportation system such that propulsion motors, on opposite sides of the vehicle, magnetically interact with the track segments to propel the vehicle along the propulsion track. Similarly, guidance rails may be attached to the opposing walls of the transportation system such that guidance actuators on opposite sides of the vehicle magnetically interact with the guidance rails to laterally guide the vehicle and/or the propulsion motors relative to the track segments. A levitation rail and/or track may be attached to an upper wall of the transportation system such that levitation actuators at a top and/or upper side of the vehicle magnetically interact with the levitation rail and/or track to levitate the vehicle and/or the propulsion motors relative to the track segments.

Hence, the vehicle may be propelled at high speed in the transportation system by the propulsion motors, for example along straight portions of the respective tracks and/or rails, guided from side-to-side by the guidance actuators interacting with guidance tracks and/or rails, and levitated (and/or at least partially levitated) by the levitation actuators interacting with levitation tracks and/or rails. However, when the vehicle is to stop at a portal (e.g. a portion of a station at which people and/or cargo and the like are loaded and/or unloaded from the payload), the vehicle in may be switched from straight portions of the respective tracks and/or rails to curved portions of the respective tracks and/or rails, though some vehicles may continue on the straight portions. Such switching may occur by way of the at least one of the guidance actuators interacting with a guidance track and/or rail. As a vehicle being switched must turn onto the curved portion, the vehicle being switched moves in a curved manner; hence physical constraints are placed on the tracks and/or rails in the region of the switch. In particular, at an outward side of the curved portion, and at an adjacent section of the straight portion, respective guidance rails are absent as, if present, respective guidance actuators on the respective side of the vehicle might physically collide with the respective guidance rail.

As such, in a region of the switch, a guidance rail may be present only along an inward side of the curved portion, and at an adjacent section of the straight portion. At least presence of a guidance rail at the inward side of the curved portion and the adjacent section of the straight portion, and absence of a guidance rail at the outward side of the curved portion and a corresponding side of the adjacent section of the straight portion, further restricts how guidance may occur in the region of the switch. For example, a guidance force towards the curved portion may be provided, but no guidance force away from the curved portion may be provided, which may cause particular problems with vehicles that are continuing on the straight portion, especially as the levitation track and/or rail may pull such vehicles towards the curved portion.

As such, provided herein is a switch for a transportation system that includes a vehicle. The switch includes a straight levitation rail and a curved levitation rail, each comprising respective magnetic material including, but not limited to, ferromagnetic materials such as iron, and the like. The curved levitation rail curves away from the straight levitation rail, and both the straight levitation rail and the curved levitation rail are to magnetically interact with a levitation actuator of the vehicle. For example, the levitation rails may be mounted hanging from an upper wall of the transportation system. The switch further comprises a magnetic gap between the straight levitation rail and the curved levitation rail, the magnetic gap comprising a region, in which the straight levitation rail and the curved levitation rail meet, of lower magnetic permeability relative to the straight levitation rail and the curved levitation rail.

Such a magnetic gap enables a vehicle that is not switched to move relative to the straight levitation rail without being pulled towards the curved levitation rail. In particular, in the region of the switch, at an outward side of the curved levitation rail, and at an adjacent portion of the straight levitation rail, a guidance rail may be absent; hence, the vehicle may not be able to easily compensate for a force on the vehicle by the curved levitation rail interacting with the levitation actuator that pulls the vehicle towards the curved levitation rail. The magnetic gap hence reduces and/or minimizes and/or eliminates such a force and/or pull, such that a vehicle continuing relative to the straight levitation rail remains centered and/or about centered on the straight levitation rail.

The switch may include other features. For example, walls within which the levitation rails and the vehicle are present may be located such that, at an outward side of the curved levitation rail and an adjacent portion of the straight levitation rail, a vehicle clears the walls as the vehicle follows the curved levitation rail from the straight levitation rail.

An aspect of the present specification provides a switch for a levitation rail for a vehicle, the switch comprising: a straight rail; a curved rail, curving away from the straight rail, the straight rail and the curved rail comprising magnetic material to magnetically interact with a motor of the vehicle; and a magnetic gap between the straight rail and the curved rail, the magnetic gap comprising a region, at which the straight rail and the curved rail meet, of lower magnetic permeability relative to the straight rail and the curved rail.

Another aspect of the present specification provides a vehicle comprising: a body; at least one levitation actuator attached to the body, the at least one levitation actuator to interact with a rail that includes a straight rail and a curved rail and a magnetic gap between the straight rail and the curved rail, the magnetic gap being of lower magnetic permeability relative to the straight rail and the curved rail; and at least one guidance actuator to interact with a guidance rail located at a same side of the straight rail from which the curved rail extends, the at least one guidance actuator controllable to guide the body along the straight rail or the curved rail.

Another aspect of the present specification provides an electromagnetic guidance system comprising: at least one rail; and a vehicle comprising at least one ski and one or more electromagnetic actuators attached to the at least one ski, such that a force is generated between the at least one electromagnetic actuator and the at least one rail; wherein: the rail is one or more of flat, curved, and twisted; and the one or more electromagnetic actuators are positioned such that the one or more electromagnetic actuators are tangent to tightly curved rail surfaces, minimally curved rail surfaces, and straight rail surfaces.

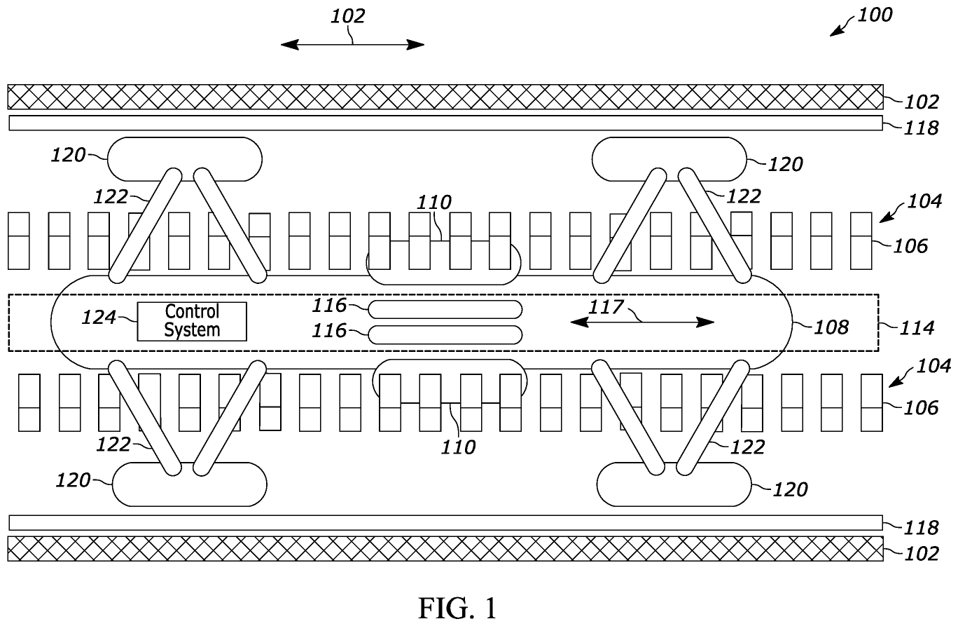

Attention is directed to FIG. 1 which schematically depicts a top view of a high-speed transport system 100. As depicted, the system 100 includes a fixed surface and/or opposing walls 102 (depicted in cross-section) which supports a track 104 comprising track segments 106 spaced periodically along the walls 102. While the track segments 106 are not depicted at the walls 102, and/or as being attached to the walls 102, the track segments 106 are nonetheless understood to be supported by; and/or attached to the walls 102. Rather, as the walls 102 may further support other structures of the system 100, as described hereafter, the walls 102 are depicted in a manner relative to other components of the system 100 to show which components are located within the walls 102. Hence, while the track segments 106 are not depicted at the walls 102, it is understood that the track 104 comprises respective track segments 106 located at respective opposite walls 102.

In some examples, the walls 102 may comprise an interior of a tube, which may be evacuated and/or at least partially evacuated using vacuum pumps (not depicted) and the like, to form a low-pressure environment. However, in other examples the tube may not be evacuated and/or the track 104 may not be in a low-pressure environment. Furthermore, the walls 102 may not be walls of a tube but may be walls of any suitable structure and/or fixed surface which supports the track 104 and other components of the system 100 as described herein. The walls 102 may further comprise corners to which the track segments 106 may be mounted. Furthermore, the high-speed transport system 100 may be deployed on land, underground, overland, overwater, underwater, and the like.

As depicted, the system 100 includes a payload 108, and the like, for transporting cargo and/or passengers, and the like, and/or any other suitable payloads. The payload 108 may be aerodynamically shaped.

The system 100 further includes propulsion motors 110 attached to opposite sides of the payload 108 which interact with respective track segments 106 to move the payload 108 along the track 104. Any suitable number of propulsion motors 110 may be attached to the payload 108 in any suitable configuration. Indeed, the payload 108 and the any suitable number of propulsion motors 110 may together form a vehicle 112 that is propelled along the track 104 by the propulsion motor 110. Indeed, the vehicle 112 may comprise the payload 108, and/or any suitable body, and the any suitable number of propulsion motors 110. The track 104 and the track segments 106 may be located on one or more sides of a tube, and the like, that include the walls 102, with any geometry of a propulsion motor 110 attached to the payload 108 adjusted accordingly; put another way, while as depicted the track 104 includes two tracks 104, the track 104 may comprise a plurality of tracks positioned to interact with a plurality of propulsion motors 110 attached to the payload 108 in any suitable configuration.

In general, the track segments 106 and a propulsion motor 110, respectively form a stator and a rotor of a homopolar linear synchronous machine. A rotor (e.g. a propulsion motor 110) may be substantially attached to the payload 108 in any of one or more orientations, such as on the top, bottom, and side of the payload 108, so long as a corresponding stator/track segment 106 is substantially connected to the wall 102 in an orientation that allows the rotor/propulsion motor 110 to pass through a track segment 106 in a direction of motion. The stator/track segments 106 may be attached to the wall 102 in any suitable orientation, so long as the rotor/propulsion motor 110 has a substantially matching orientation to allow the rotor/propulsion motor 110 to pass through the stator/track segments 106.

In particular, the propulsion motors 110 are propelled along the track 104 using magnetic flux produced by the propulsion motors 110. One example of a propulsion motor 110 and track 104 and track segments 106 is described, for example, in Applicant's co-pending application titled “HOMOPOLAR LINEAR SYNCHRONOUS MACHINE” having PCT Patent Application No. PCT/US2019/051701, filed Sep. 18, 2019, and which claims priority from U.S. Patent Application No. 62/733,551, filed Sep. 19, 2018, and the contents of each are incorporated herein by reference.

As depicted, the system 100 further includes a levitation rail 114, for example attached to a ceiling and/or an upper side of the tube, and the like, formed by the walls 102. Put another way, while no wall 102 is depicted as supporting the levitation rail 114, the system 100 may comprise an upper wall 102 to which the levitation rail 114 is attached and/from which the levitation rail 114 is suspended. The levitation rail 114 generally comprises magnetic material (e.g. a ferromagnetic material such as iron, and the like) and assists with levitating the vehicle 112 and/or the propulsion motors 110 relative to the track 104. For example, as depicted, the vehicle 112 further comprises at least one levitation actuator 116 attached to a top side of the vehicle 112 (e.g. as depicted two levitation actuators 116); the levitation actuators 116 are generally configured to generate a magnetic force to attract the vehicle 112 to the levitation rail 114, to oppose gravity, and generally levitate the vehicle 112. The levitation rail 114 is depicted in outline to show a position of the levitation rail 114 relative to the levitation actuators 116 and the vehicle 112. Furthermore, while two levitation actuator 116 are depicted, the vehicle 112 may comprise any suitable number of levitation actuators 116, which may be symmetrically arranged in rows relative to a longitudinal and/or movement axis 117 of the vehicle 112 and/or relative to a direction of motion of the vehicle 112.

One example of a levitation actuator 116 and levitation rail 114 is described, for example, in Applicant's co-pending application titled “A FORCE-PRODUCING ELECTROMAGNETIC MACHINE” having PCT Patent Application No. PCT/US2020/059012, filed Nov. 5, 2020, and which claims priority from U.S. Provisional Patent Applications Ser. Nos. 62/931,987, 62/931,935, 62/932,013, 62/932,077, 62/932,113, all of which were filed on Nov. 7, 2019, and further claims priority from U.S. Provisional Patent Application Ser. No. 62/945,978, filed on Dec. 10, 2019, and the contents of each are incorporated herein by reference.

As depicted, the system 100 further includes a pair of opposing guidance rails 118, for example attached to, and/or supported by respective walls 102. The guidance rails 118 may be located above or below the track 104 and/or the track segments 106. The guidance rails 118 generally comprises magnetic material (e.g. a ferromagnetic material such as iron, and the like) and assists with laterally guiding the vehicle 112 and/or the propulsion motors 110, from side-to-side relative to the track 104. For example, as depicted, the vehicle 112 further comprises four guidance actuators 120 attached to opposite sides the vehicle 112, for example using optional struts 122 to locate the guidance actuators 120 above or below the propulsion motors 110 to interact with the guidance rails 118 which are correspondingly located above or below the track 104, though any suitable geometric configuration is within the scope of the present specification. While two guidance actuators 120 are depicted on each side of the vehicle 112, the vehicle 112 may comprise any suitable number of guidance actuators 120. The guidance actuators 120 are generally configured to generate a magnetic force to attract the vehicle 112 to respective guidance rails 118, for example to laterally guide the vehicle 112 and/or the propulsion motors 110 relative to the track 104.

One example of a guidance actuator 122 and guidance rail 120 is described, for example, in Applicant's co-pending application titled “FORCE-PRODUCING ELECTROMAGNETIC ACTUATOR” having PCT Patent Application No. PCT/US2020/059028, filed Nov. 5, 2020, and which claims priority from U.S. Provisional Patent Applications Ser. Nos. 62/931,987, 62/931,935, 62/932,013, 62/932,077, 62/932,113, all of which were filed on Nov. 7, 2019, and further claims priority from U.S. Provisional Patent Application Ser. No. 62/945,978, filed on Dec. 10, 2019, and the contents of each are incorporated herein by reference.

In particular, the vehicle 112 may further comprise a control system 124, such as any suitable combination of one or more computing devices, processors, sensors, and the like, configured to control the propulsion motors 110, the levitation actuators 116 and the guidance actuators 120 to propel the vehicle 112 along the track 104 and control a position of the vehicle 112 and/or the propulsion motors 110 relative to the track 104 by controlling the magnetic forces of the levitation actuators 116 and the guidance actuators 120. The control system 124 may be further configured to switch the vehicle 112 from a straight portion of the track 104 and the rails 114, 118 to a curved portion of the track 104 and the rails 114, 118, for example towards a portal of the system 100, as described hereafter.

While not depicted, the system 100 may further comprise a suspension and/or location system to suspend and/or locate the propulsion motor 110 relative to the track segments 106, for example in addition to the levitation actuators 116 and levitation rail 114. Such a suspension and/or location system may be mechanical (e.g. wheels and a corresponding track therefor), and/or of any other suitable configuration.

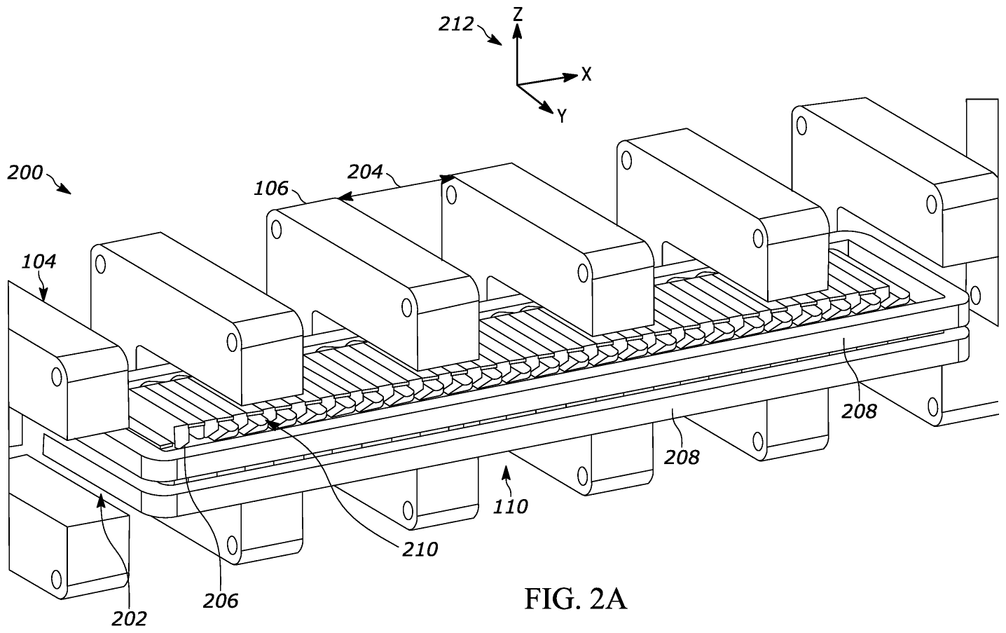

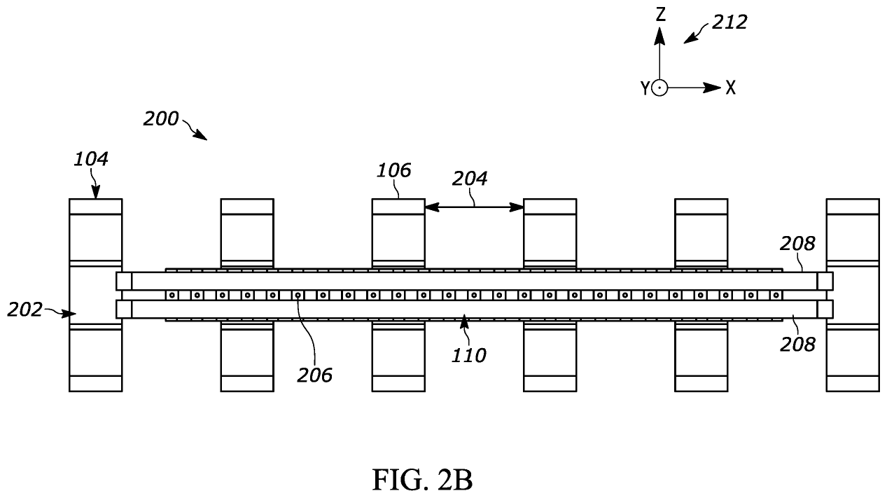

Attention is next directed to FIG. 2A and FIG. 2B which respectively depict perspective view and a side view of a homopolar linear synchronous machine (HLSM) 200 according to present examples. In particular FIG. 2A depicts a perspective view of a portion of the track 104, including a portion of the track segments 106 and an example propulsion motor 110. As depicted, the track segments 106 may be substantially C-shaped and/or horseshoe shaped, and the like, such that a propulsion motor 110 may pass through a center “hollow” portion 202 of a track segment 106, as seen in both FIG. 2A and FIG. 2B. As depicted, the propulsion motor 110 is passing through a plurality of track segments 106. The track 104, and specifically the track segments 106, may function as a “stator” of the HLSM 200, and the propulsion motor 110 may function as a “rotor” of the HLSM 200, such that, together, the track 104 (e.g. the track segments 106) and the propulsion motor 110 form the HLSM 200.

As depicted, the HLSM 200, as described herein, may include two or more laterally offset track segments 106, such that there is a gap 204 between adjacent track segment 106. Hence, the track segments 106 are generally magnetically salient, such that a varying magnetic flux may be produced across the track segments 106 and the gaps 204, for example by at least magnetic flux inducing device of the propulsion motor 110, such as at least one field coil and/or a at least one magnet, described in more detail below.

Such magnetic flux may be about constant in a track segment 106, and the resulting magnetic flux in the gap 204 varies, relative to the flux in a track segment 106, in a direction of motion (e.g. along the track 104).

In particular, the propulsion motor 110 comprises at least one ferromagnetic core 206 having opposite ends joined by a body forming a magnetic flux pathway between the opposite ends. For example as depicted, the propulsion motor 110 comprises a plurality of ferromagnetic cores 206, arranged along the track 104 and/or along a longitudinal axis of the propulsion motor 110, that are block shaped and/or rectangular in cross-section that are shaped to fit into the hollow portions 202 of the track segments 106. The magnetic flux pathway formed by the at least one ferromagnetic core 206 is understood to complete a magnetic flux pathway formed in the track segments 106, for example, with each track segment 106 forming a respective portion of a magnetic flux pathway completed by respective ferromagnetic cores 206.

The propulsion motor 110 further comprises at least one magnetic flux inducing device 208 to induce a first magnetic flux in the at least one ferromagnetic core 206 along the magnetic flux pathway. As depicted, the at least one magnetic flux inducing device 208 comprises a pair of field coils that induce a first magnetic flux in the at least one ferromagnetic core 206 along the magnetic flux pathway and through respective track segments 106. However, the at least one magnetic flux inducing device 208 may alternatively comprise magnets, for example embedded in the ferromagnetic cores 206.

The propulsion motor 110 further comprises armature coils 210 (as best seen in FIG. 2A) to induce a varying second magnetic flux in the at least one ferromagnetic core 206 perpendicular to the magnetic flux pathway formed by the at least one ferromagnetic core 206 and the track segments 106, to induce a propulsion force perpendicular to the magnetic flux pathway. In general, the armature coils 210 of the propulsion motor 110 may generate the second magnetic flux through the track segments 106 that results in pole pairs (e.g. a sequence of magnetically-polarized regions) which interact with the magnetic flux, generated by the at least one magnetic flux inducing devices 208, to propel the propulsion motor 110 along the track 104.

In particular, the track segments 106 are arranged such that the hollow portions 202 of the track segments 106 form a substantially continuous path for a rotor, and specifically the propulsion motor 110, to move relative to the track segments 106 and/or the track 104. Hence, a “stator” and/or track 104 and/or track segments 106, may be substantially fixed relative to the rotor/propulsion motor 110 of the HLSM 200. Together, the track 104 and the propulsion motor 110 comprise a propulsion system for moving the payload 108 and/or the vehicle 112 relative to the wall 102, in either direction along the track 104.

However, the HLSM 200 may comprise track segments and ferromagnetic cores of any suitable shape and/or configuration. In particular, other examples of track segments and ferromagnetic cores is described, for example, in Applicant's co-pending application titled “PROPULSION MOTOR TOPOLOGIES” filed on a same day as the present application, having Attorney Docket Number P10975US00, and the contents of which are incorporated herein by reference. For example, in some examples the HLSM 200 may comprise track segments which are not “C” shaped ferromagnetic cores, and which present flat surfaces to complementary shaped ferromagnetic cores of a propulsion motor such that the ferromagnetic cores of such a propulsion motor move along the flat surfaces of the ferromagnetic cores (e.g. and not in a hollow).

Hence, while hereafter examples are described with respect to the ferromagnetic cores 206 of the propulsion motor 110, and the track segments 106, having the shape depicted in FIG. 2A and FIG. 2B, it is understood that present examples may be adapted for ferromagnetic cores and track segments of any suitable shapes.

For clarity, an XYZ cartesian coordinate system 212 is depicted in FIG. 2A and FIG. 2B, showing a convention that will be used throughout the present specification. For example, an “X” axis is understood to be along the track 104, a “Y” axis is understood to be in a “left” and “right” direction, lateral to the track 104, for example in a direction between backs of track segments 106 and hollow portions 202, and the “Z” axis is understood to be in an “up” and “down” direction.

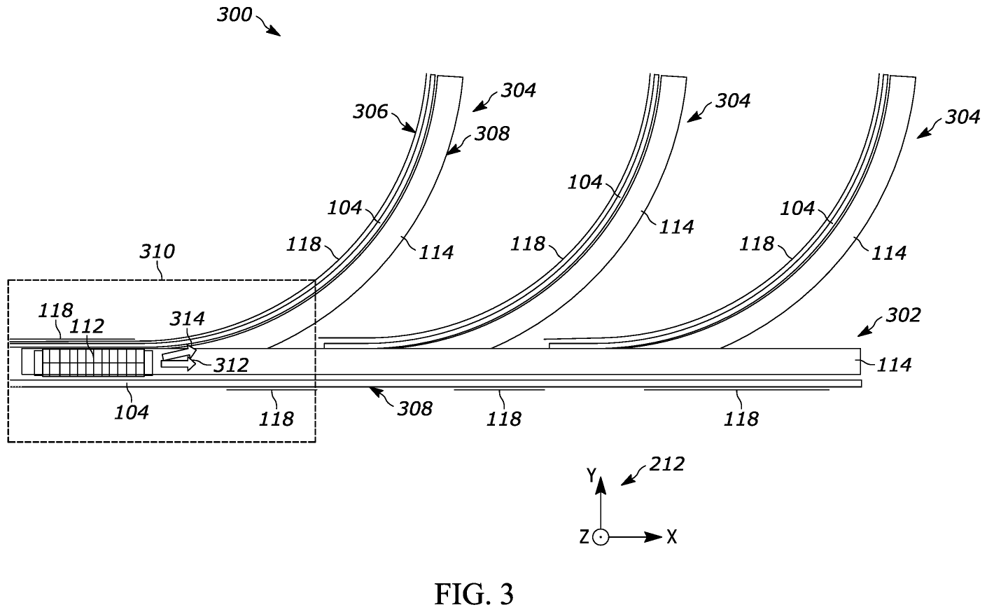

Attention is next directed to FIG. 3 which depicts a top view of a switch 300 for a vehicle 112 of the system 100. It is understood that the switch 300 may be a component of the system 100 and comprises respective portions of the track 104 and the rails 114, 118. As described in more detail below. As depicted, the levitation rail 114 is partially transparent to show a location of the vehicle 112 “under” the levitation rail 114.

The switch 300 is generally configured to enable a vehicle 112 to travel along a straight portion 302 of the track 104 and the rails 114, 118, or switch to curved portions 304 of the track 104 and the rails 114, 118, for example to travel to a portal and/or station. Put another away, a curved portion 304 of the track 104 and the rails 114, 118 may be to a portal and/or a station.

As used herein, the term “portal” may include a portion of a station at which people and/or cargo and the like are loaded and/or unloaded from the payload 108, similar to a platform of a train station, and the term “station” may include a facility, at which the vehicle 112 may stop, that includes one or more portals. As depicted, for example, there are three curved portions 304 which may lead to one of three respective portals of a station. While three curved portions 304 are depicted, the switch 300 may include as few as one curved portion 304, two curved portions 304, more than three curved portions 304 and/or any suitable number of curved portions 304.

Furthermore, as depicted, a respective curved portion 304 may include an inward side 306 and an outward side 308. An inward side 306 is understood to refer to a side of a curved portion 304 that corresponds to an inner radius of a curved portion 304, and outward side 308 is understood to refer to a side of a curved portion 304 that corresponds to an outer radius of a curved portion 304. Hence, the sides 306, 308 are generally on opposite sides of a curved portion 304.

For clarity, the inward side and outward side convention will also be used to describe the track 104, the guidance rails 118, and sides of the vehicle 112, whether along the straight portion 302 or the curved portion 304. For example, along the straight portion 302, components along a side that correspond to the inward side 306 of the curved portion 304 may also be described as being located at the inward side 306, and components along an opposite side may also be described as being located at the outward side 308.

As depicted, the vehicle 112 is understood to be travelling along the straight portion 302 and, in a region 310, the vehicle 112 may either continue on the straight portion 302, as represented by the arrow 312, or switch to a first curved portion 304, as represented by the arrow 314. In general, the vehicle 112 may switch from the straight portion 302 to a curved portion 304 by the control system 124 providing a command to guidance actuators 120, at a side of the vehicle 112 corresponding to an inward side 306 of the curved portion 304, to increase a guidance force between the guidance actuators 120 and the guidance rail 118 at the inward side 306 to pull the vehicle 112 onto the curved portion 304. Otherwise, to continue on the straight portion 302, no guidance force is applied and/or a guidance force is not increased.

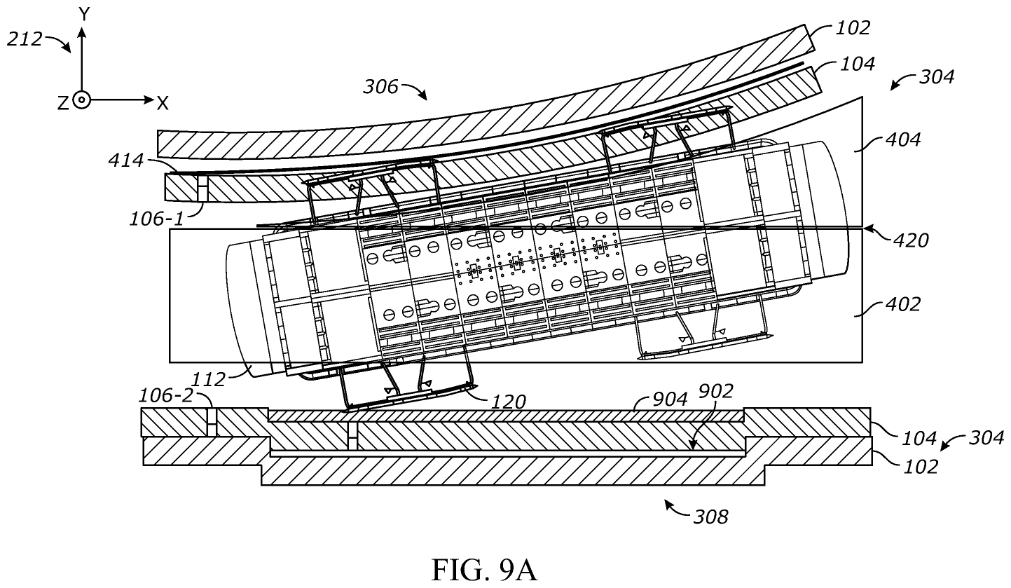

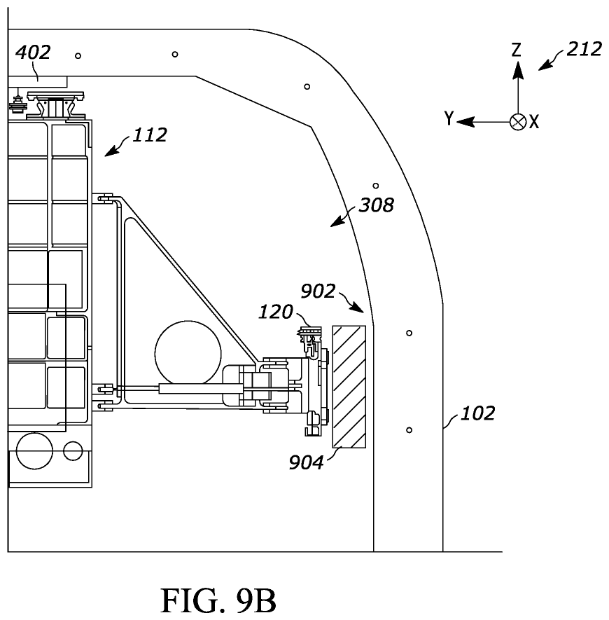

It is furthermore understood from FIG. 3 that, at the switch 300, a guidance rail 118 may be absent at the straight portion 302 in regions where the curved portions 304 meet the straight portion 302 (e.g. at the outward side 308). For example, as depicted, in the region 310, the guidance rail 118 at the straight portion 302, at a side opposite where the curved portion 304 meets the straight portion 302, ends prior to where the portions 302, 304 meet, continues between curved portions 304, but is absent where further portions 302, 304 meet. Such absence of the guidance rail 118 is to ensure that a vehicle 112 switching to a curved portion 304 does not collide with the guidance rail 118 as a “back end” of the vehicle 112 will generally move through a curve that may be beyond a location of the guidance rail 118 at this side, presuming such a guidance rail 118 was present. Such a swinging out of the “back end” of the vehicle 112 is described in more detail with respect to FIG. 9.

As the guidance rail 118 is absent on the side where the portions 302, 304 meet, a vehicle 112 continuing along the straight portion 302 (e.g. rather than switching to the curved portion 304) may not easily compensate for any “pull” towards the curved portion 304 by the curved levitation rail 114 (e.g. in the region 310). Put another way, the levitation actuators 116 may generally operate such that, as a whole, the levitation actuators 116 are generally centered on the levitation rail 114 (e.g. as best seen in FIG. 1); as such, when a shape of the levitation rail 114 changes in the region 310, the levitation actuators 116, and hence the vehicle 112, may be generally pulled towards the curved portion 304.

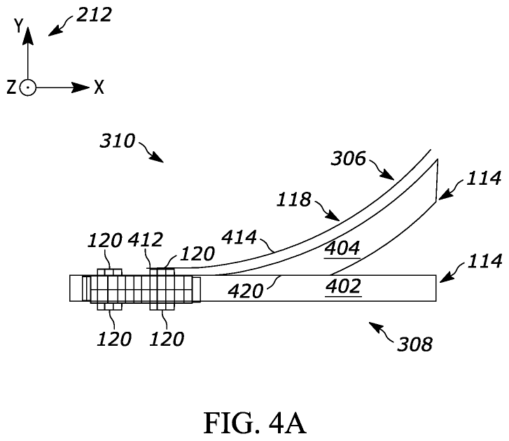

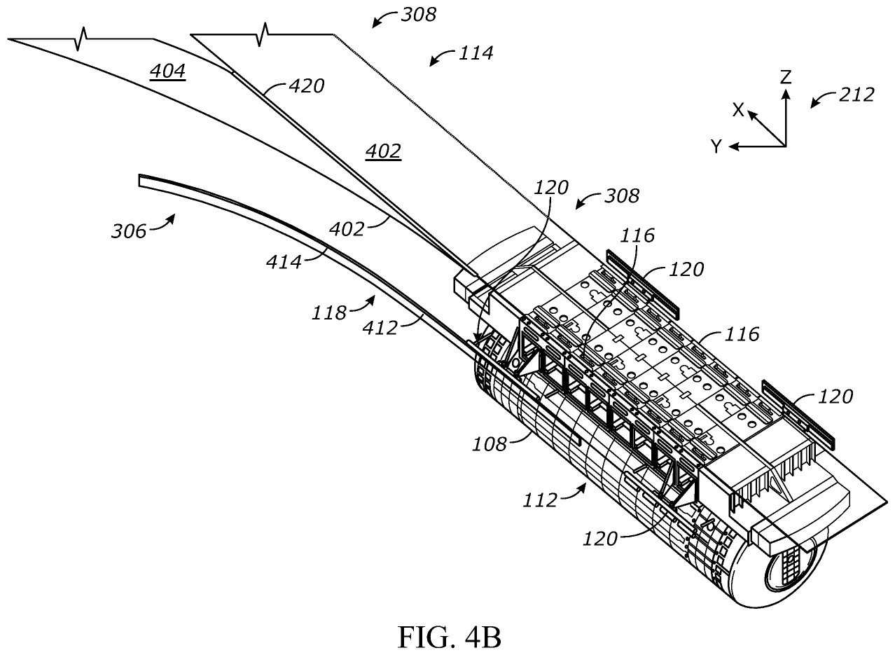

Attention is next directed to FIG. 4A, which depicts a top view of the region 310 in more detail, and FIG. 4B which depicts a perspective view of the region 310, both without the propulsion track 104 for clarity. Also for clarity, FIG. 4A and FIG. 4B depict a straight rail 402 and a curved rail 404 of the levitation rail 114, and a straight rail 412 and a curved rail 414 of the guidance rail 118. The rail 402, 412 are understood to be part of the straight portion 302 of the track 104 and the rails 114, 118, and the rail 404, 414 are understood to be part of the curved portion 304 of the track 104 and the rails 114, 118.

Furthermore, it is understood that the straight rail 402 may comprise a primary portion of the levitation rail 114, the straight rail 402 extending away from the curved rail 404 in opposite directions, and the curved rail 404 may be towards a portal and/or a station for the vehicle 112.

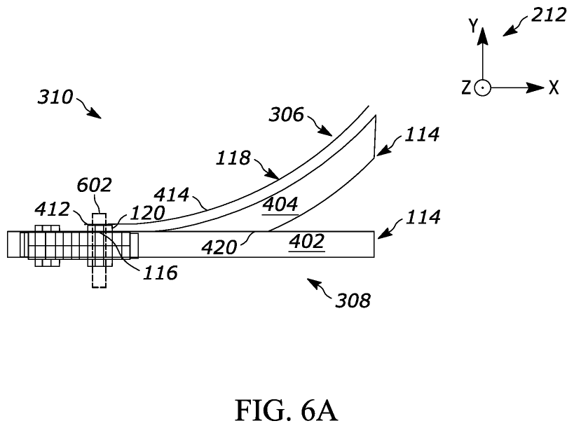

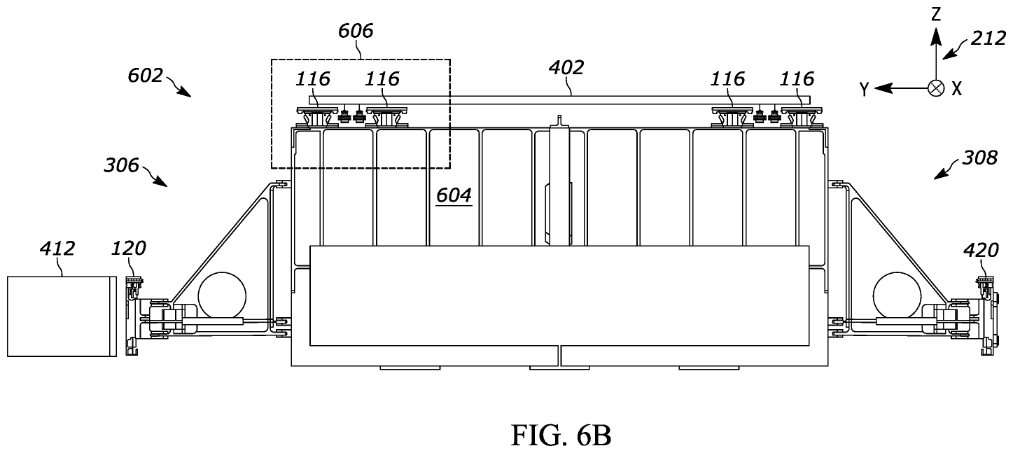

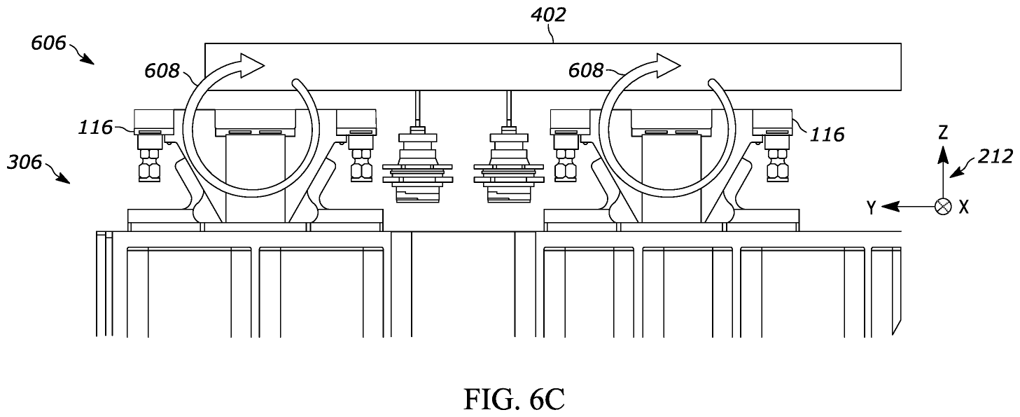

Also depicted in FIG. 4A and FIG. 4B are details of the vehicle 112 according to certain non-limiting examples. In particular, as depicted, the vehicle 112 comprises four guidance actuators 120, two at the inward side 306 of the guidance rail 118, and two on an opposite side (e.g. corresponding to the outward side 308) where the guidance rail 118 is absent. The vehicle 112 further comprises fours rows of levitation actuators 116 (e.g. two rows to a side, as better seen in FIG. 6B), for example arranged symmetrically about a longitudinal axis of the vehicle 112 and/or arranged symmetrically about a direction of motion of the vehicle 112.

In particular, both the straight rails 402, 412 and the curves rails 404, 414 comprise magnetic material, such as any suitable ferromagnetic material, and the like.

In particular, the switch 300 comprises: the straight rail 402; and the curved rail 404, curving away from the straight rail 402, the straight rail 402 and the curved rail 404 and the curved rail comprising magnetic material to magnetically interact with a motor of the vehicle 112, such as the levitation actuators 116. Furthermore, to prevent the curved rail 404 from pulling a vehicle 112 from continuing relative to the straight rail 402, rather than switching to the curved rail 404, the switch 300 further comprises a magnetic gap 420 between the straight rail 402 and the curved rail 404, the magnetic gap 420 comprising a region at which the straight rail and the curved rail meet, such a region being of lower magnetic permeability relative to the straight rail 402 and the curved rail 404.

It is further understood from FIG. 4B that the switch 300 comprises a guidance rail 118 located along a same side of the straight rail 402 from which the curved rail 404 extends (e.g. at the inward side 306), the guidance rail 118 further following (e.g. via the curved rail 414) an inner radius of the curved rail 404, such that the guidance rail 118 curves away from the straight rail 402 in the region of the magnetic gap 420, the guidance rail 118 to interact with a first guidance actuator 120 of the vehicle 112. Furthermore, no corresponding guidance rail 118 is located at an opposite side (e.g. the outward side 308) of the straight rail 402 and the curved rail 404 such that a second guidance actuator 120 of the vehicle 112, opposite the first guidance actuator 110, is inoperative in the region of the magnetic gap 420. Furthermore, as depicted, the guidance rail 118 is understood to be perpendicular to the straight rail 402 and the curved rail 404 of the levitation rail 114; in particular, the straight rail 402 and the curved rail 404 may be in an “XY” plane of the coordinate system 212, and the guidance rail 118 may be in various “XZ” and/or “YZ” planes of the coordinate system 212.

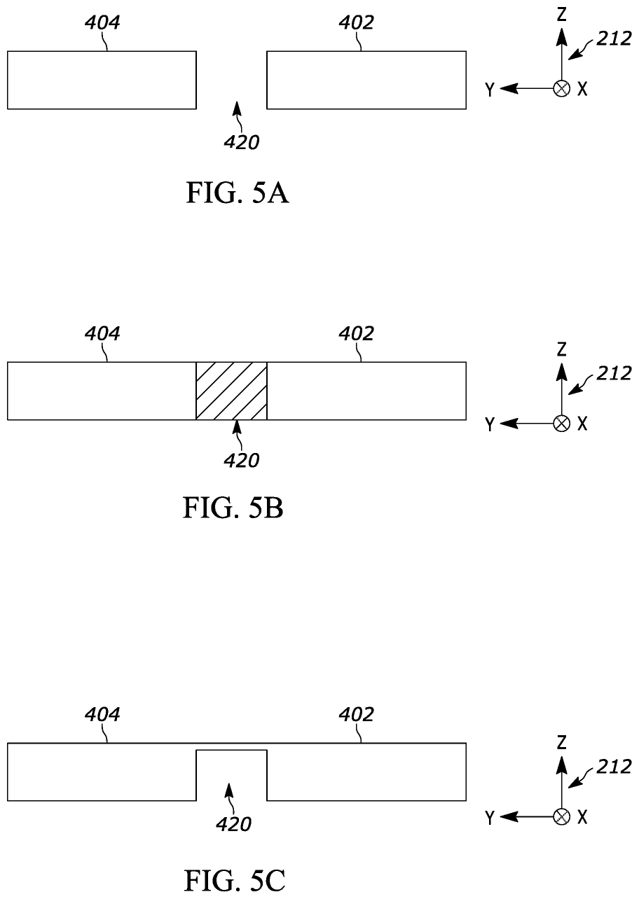

Attention is next directed to FIG. 5A, FIG. 5B and FIG. C, each of which depict a portion of the straight rail 402 and the curved rail 404 separated by the magnetic gap 420, for example in cross-section along the “YZ” plane of the coordinate system 212. With reference to FIG. 5A, the magnetic gap 420 may comprise an airgap between the straight rail 402 and the curved rail 404. Put another way, the magnetic gap 420 may comprise an air gap.

With reference to FIG. 5B, the magnetic gap 420 may comprise non-magnetic material between the straight rail 402 and the curved rail 404, such as a non-magnetic metal (e.g. aluminum), a plastic, and the like. Put another way, the magnetic gap 420 may comprise non-magnetic material. Hence, in these examples, it is understood that the magnetic gap 420 may not be a physical gap between the straight rail 402 and the curved rail 404, but a region of lower magnetic permeability relative to the straight rail 402 and the curved rail 404.

With reference to FIG. 5C, the magnetic gap 420 may comprises one or more of a groove and a slot between the straight rail 402 and the curved rail 404. Such a groove and/or slot may include a magnetic material, such as a same magnetic material of one or more of the straight rail 402 and the curved rail 404, but of lower volume and/or density relative to the straight rail 402 and the curved rail 404. For example, as depicted, the straight rail 402 and the curved rail 404 meet at a “top side”, but there is otherwise a gap and/or an airgap between the straight rail 402 and the curved rail 404. Regardless, at the magnetic gap 420, the combination of the magnetic material and the airgap has a lower overall and/or average magnetic permeability than the straight rail 402 and the curved rail 404.

Hence, from the examples of FIG. 5A, FIG. 5B and FIG. 5C, it is understood that the magnetic gap 420 may not be a physical gap between the straight rail 402 and the curved rail 404, but a region of lower magnetic permeability relative to the straight rail 402 and the curved rail 404.

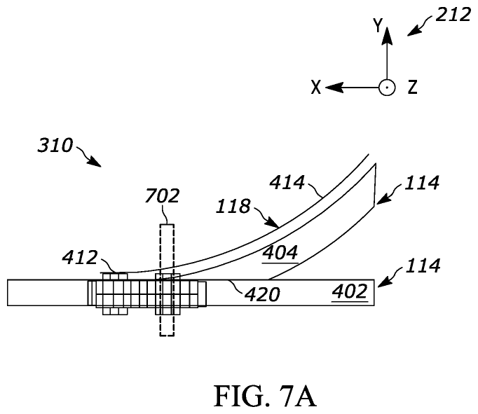

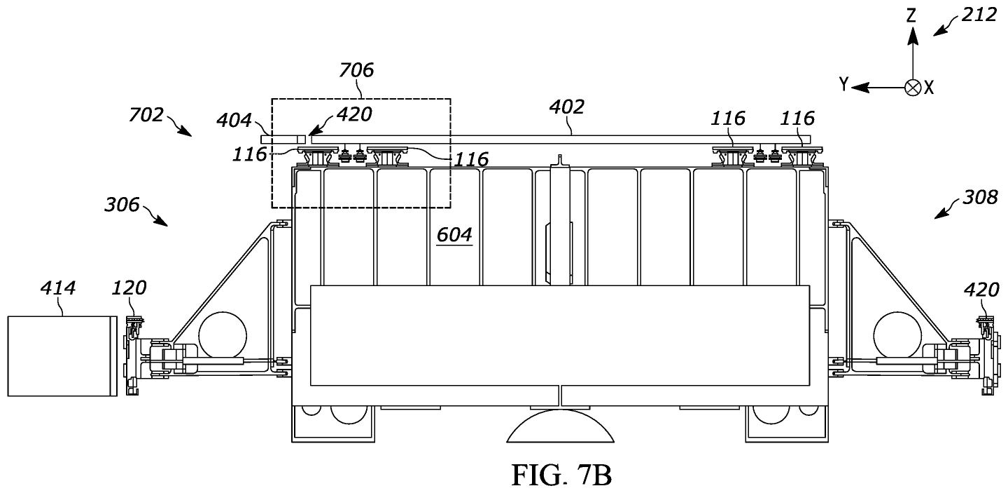

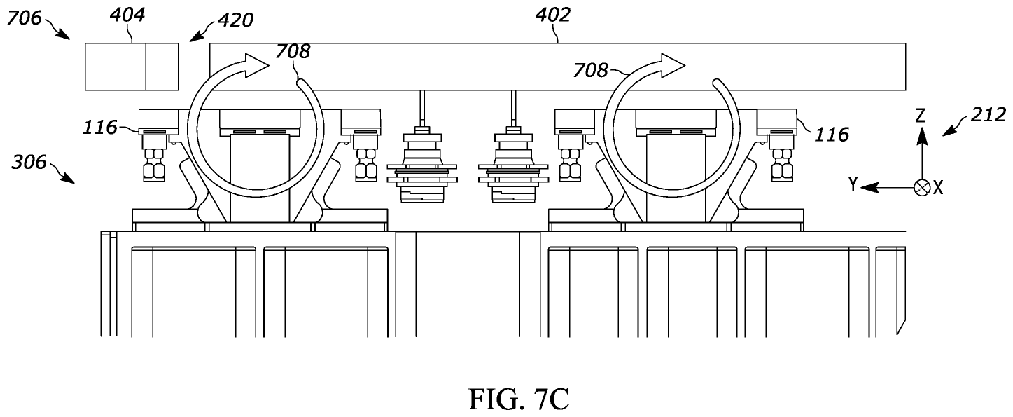

The effect of the magnetic gap 420 is next described with respect to FIG. 6A, FIG. 6B and FIG. 6C, and FIG. 7A, FIG. 7B and FIG. 7C; in these drawings, it is understood that the vehicle 112 is moving along the straight portion 302 and moving towards the first curved portion 304 similar to as depicted in FIG. 3 and FIG. 4A (e.g. following the arrow 312 of FIG. 3).

Attention is next directed to FIG. 6A, FIG. 6B and FIG. 6C. FIG. 6A depicts a top view of the region 310, similar to FIG. 4A, and shows the vehicle 112 travelling relative to the straight rails 402, 412, and just before the vehicle 112 reaches the curved rails 404, 414. A region 602 is indicated, where guidance actuators 120 of the vehicle 112 and the straight guidance rail 412 are located at the inward side 306.

FIG. 6B depicts an end view of a structure 604 (which may colloquially be referred to as the bogie) of the vehicle 112 to which the motors 116, 120 are attached (e.g. as well as the propulsion motors 110), in a direction of motion (e.g. along the “X” axis of the coordinate system 212) and showing the straight rails 402, 414 in a region 602 (e.g. see FIG. 6A), relative to the motors 116, 120. While the payload 108 is not depicted, it is nonetheless understood to be present (e.g. at an underside of the structure 604). FIG. 6B clearly shows that the levitation actuators 116 are arranged in four parallel rows, two rows to a side of the vehicle 112), which are centered, as a group, on the straight rail 402.

FIG. 6B further depicts that guidance actuators 120 at the inward side 306 interact with a straight guidance rail 412, while there is no guidance rail 412 at the outward side 308.

FIG. 6C depicts details of a region 606 of FIG. 6B. In particular, an outermost levitation actuator 116, in this example, is at an edge of the straight rail 402. Similarly, with reference to FIG. 6B, it is understood that a corresponding outermost levitation actuator 116 is at an opposite side of the vehicle 112 and at an opposite edge of the straight rail 402.

FIG. 6C further depicts respective magnetic flux paths 608 of the levitation actuator 116 showing that the magnetic flux path 608 for the outermost levitation actuator 116 is through a corner and/or an edge of the straight rail 402.

Attention is next directed to FIG. 7A, FIG. 7B and FIG. 7C. FIG. 7A depicts a top view of the region 310, similar to FIG. 4A, and shows the vehicle 112 travelling relative to the straight rails 402, 412, and as the vehicle 112 reaches the curved rails 404, 414.

FIG. 7B depicts a similar view of the vehicle 112 as depicted in FIG. 6B, but in a region 702 of FIG. 6A which includes where the rails 402, 404 meet the magnetic gap 420. FIG. 7B further depicts that guidance actuators 120 at the inward side 306 now interact with a curved rail 414, while there is no guidance rail at the outward side 308.

FIG. 7C depicts details of a region 706 of FIG. 7B. In particular, the outermost levitation actuator 116 is still at an edge of the straight rail 402 but is also at least partially located adjacent the magnetic gap 420. It is understood that the vehicle 112 may continue along the straight rail 402, or switch to the curved rail 404.

FIG. 7C further depicts respective magnetic flux paths 708 of the levitation actuator 116 showing that the magnetic flux path 708 for the outermost levitation actuator 116 is still through a corner and/or an edge of the straight rail 402, and a width of the magnetic gap 420 is selected such that the magnetic flux path 708 for the outermost levitation actuator 116 is not changed by the presence of the curved rail 404. Put another way, a width of the magnetic gap 420 between the straight rail 402 and the curved rail 404 is selected such that, when the vehicle 112 continues along the straight rail 404, the curved rail 404 does not influence and/or change the magnetic flux paths 708 for the levitation actuators 116.

In some examples, the magnetic gap 420 may be at least as wide as a nominal airgap between a levitation actuator 116 and the rail 114, as the vehicle 112 moves along the track 104 (e.g. a distance between the levitation actuators 116 and the rail 114 as the vehicle 112 moves along the track 104). Furthermore, the magnetic gap 420 may be at least narrower than a length of a levitation actuator 116 that is crossing the magnetic gap 116.

In general, the magnetic gap 420 may be approximately as wide as a magnetic pole of a levitation actuator 116 (e.g. such magnetic poles described, for example, in Applicant's co-pending application titled “A FORCE-PRODUCING ELECTROMAGNETIC MACHINE” having PCT Patent Application No. PCT/US2020/059012, filed Nov. 5, 2020, and which claims priority from U.S. Provisional Patent Applications Ser. Nos. 62/931,987, 62/931,935, 62/932,013, 62/932,077, 62/932,113, all of which were filed on Nov. 7, 2019, and further claims priority from U.S. Provisional Patent Application Ser. No. 62/945,978, filed on Dec. 10, 2019, and the contents of each are incorporated herein by reference).

Furthermore, the magnetic gap 420 may be approximately as wide as a magnetic pole of a levitation actuator 116 such that a position of a levitation actuator 116 that traverses the switch 300 along the straight portion 302 (e.g. without being switched along a curved portion 304) does not cause a levitation actuator 116 to pass underneath an opposite side of the rail 114 (e.g. the curved rail 404), and remains, in some examples at least about 1 mm (among other possibilities) away from the edge of the opposite side of the rail 114 (e.g. the curved rail 404). The position of the rail 114 is such that the levitation actuator interacts dominantly with a current rail segment (e.g. of the straight rail 402), and does not interact dominantly with an opposite rail segment (e.g. of the curved rail 404) across the magnetic gap 420.

However, when the vehicle 112 is switched to the curved rail 404, the magnetic flux paths 708 for the levitation actuators 116 interact with the curved rail 404.

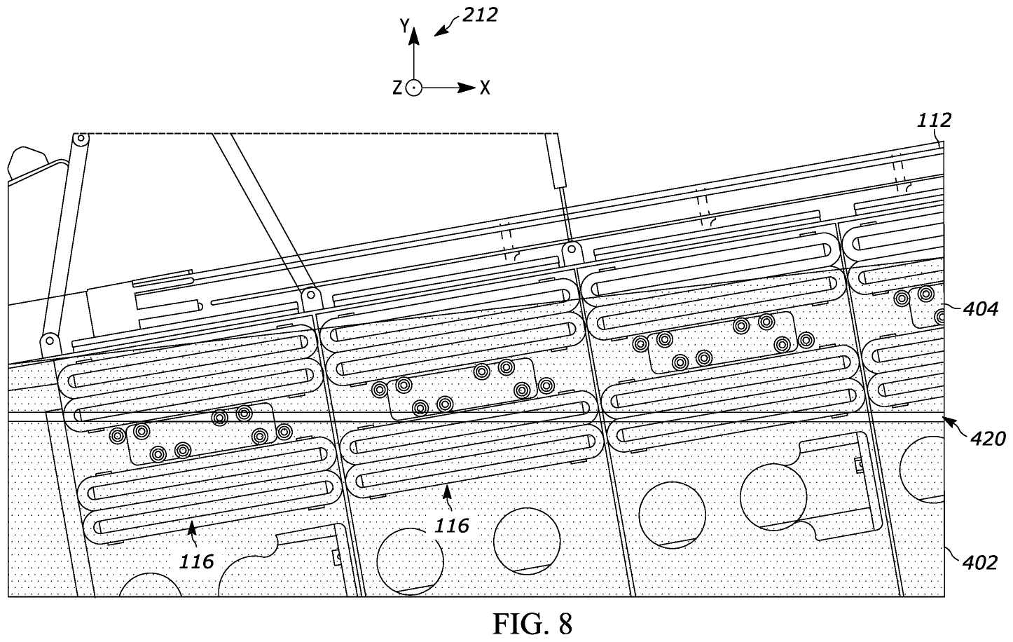

The width of the magnetic gap 420 may be further selected such that, as a levitation actuator 116 crosses the magnetic gap 420, when the vehicle 112 is switched to the curved rail 404, there is minimal disruption to the movement of the vehicle 112. Such crossing of the magnetic gap 420 is depicted in FIG. 8 which depicts a top view of a portion of the vehicle 112 showing the levitation actuators 116, as the levitation actuators 116 cross the magnetic gap 420 from the straight rail 402 to the curved rail 404. It is apparent that an area of the magnetic gap 420, as compared to an area of the levitation actuators 116, is relatively small; for example less than about 10% of a levitation actuator 116, as the levitation actuator 116 crosses the magnetic gap 420, is in a region of the magnetic gap 420, with a remainder (e.g. greater than about 90%) of the levitation actuator 116 interacting with the straight rail 402 and/or the curved rail 404. In another example, an area of the magnetic gap 420, as compared to an area of the levitation actuators 116, less than or equal to about 5% of a levitation actuator 116, as the levitation actuator 116 crosses the magnetic gap 420, may be in a region of the magnetic gap 420, with a remainder (e.g. greater than about 95%) of the levitation actuator 116 interacting with the straight rail 402 and/or the curved rail 404.

However, such disruption may be further minimized by the control system 124 slowing the vehicle 112 to reduce eddy currents in the curved rail 404. For example, the control system 124 may include sensors which detect a position of the vehicle 112 relative to the magnetic gap 420; when the control system 124 determines that the vehicle 112 is approaching the magnetic gap 420 along the straight rail 402, and that the vehicle 112 is to switch to the curved rail 404, the control system 124 may slow the vehicle 112 to a given switching speed.

As has been previously discussed, the track 104 and the rails 114, 118 are generally supported by, and/or contained within, the walls 102. As has been previously described, as the vehicle 112 switches to the curved rail 404, as a “back end” of the vehicle 112 will generally move through a curve, for example such that the back end of the vehicle 112 swings outward (e.g. towards the outward side 308) and hence towards any portion of a wall 102 in this location. As such, the walls 102 may be located to prevent the “back end” of the vehicle 112 and/or a guidance actuator 120 located at the back end, from colliding with the walls 102. For example, FIG. 9A depicts a top view of the vehicle 112 switching from the straight rail 402 to the curved rail, with a guidance actuator 120 at “back end”, at the outward side 308, swinging out towards a wall 102 at the outward side 308. However, the wall 102 at the outward side 308 is shaped such that the guidance actuator 120 does not hit the wall 102; for example, there may a recess 902 in the wall 102 to allow for such clearance. While the recess 902 is depicted as step, the recess 902 may be formed by a gradual and/or transitional broadening of the wall 102 at the outward side 308; furthermore, such broadening may occur over a large distance as compared to a distance of the switch 300 along the track 104, such as starting about 1 km before, and 1 km after, among other possibilities (e.g. including, but not limited to 250 m, 500 m, 2 kms, etc.). Hence, the walls 102 and/or the outward side 308, may be shaped in any suitable manner and/or over any suitable distance, to allow for the aforementioned clearance.

Put another way, the switch 300 generally further comprises walls 102 within which the straight rail 402, the curved rail 404 and the guidance rail 118 are located, the walls 102 located such that the second guidance actuator 120 of the vehicle 112 (e.g. assuming a guidance actuator 120 interacting with the curved rail 414 of the guidance rail 118 is a first guidance actuator 110) clears the walls 104 at an outward side 308 of the straight rail 402 and the curved rail 404 when the vehicle follows the curved rail 404 from the straight rail 402.

For example, the switch 300 may be provided with a clearance zone 904 in a region of the magnetic gap 420, with a geometry of the walls 102 selected such that guidance actuators 120 at an outward side 308 of the vehicle 112 are located in the clearance zone 904 when the vehicle 112 switches from the straight rail 402 to the curved rail 404. It is understood that the walls 102 are located adjacent the clearance zone 904, and that the clearance zone 904 comprises a region through which a “back end” of the vehicle 112 may “swing” when switching to the curved rail 404 without hitting the walls 102, or other components of the system 100.

FIG. 9B depicts an end view of a portion of the walls 102 in the “YZ” plane of the coordinate system 212, showing the clearance zone 904 in the region of the recess 902, relative to the guidance actuator 120 at the “back end” of the vehicle 112 at the outward side 308.

Returning to FIG. 9A, location of the track 104 is also depicted; while only a few representative track segments 106 are depicted, the track segments 106 as depicted in FIG. 1, FIG. 2A and FIG. 2B are nonetheless understood to be present.

In particular, a first portion of the track 104 and/or first track segments 106-1 “follows” the curved guidance rail 414 at the inward side 306 along the curved portion 304. Similarly, a second portion of the track 104 and/or second track segments 106-2 follows the wall 102 at the outward side 308 and may follow the recess 902 such that propulsion motors 110 (not depicted in FIG. 9A, but nonetheless understood to be present), “clear” the second track segments 106-2 when the vehicle follows the curved rail 404 from the straight rail 402. Furthermore, the second track segments 106-2 extend in opposite directions on the outward side 308 to provide propulsion to the vehicle 112, as there may generally be no first track segments 106-1 located along the inward side 306 of the straight rail 402 adjacent the curved rails 404.

Put another way, the switch 300 may further comprise: first track segments 106-1 to interact with a first propulsion motor 110 of the vehicle 112 (e.g. at the inward side 306), the first track segments 106-1 located along a first side (e.g. the inward side 306) of the straight rail 402 from which the curved rail 404 extends, the first track segments 106-1 further following an inner radius of the curved rail 404; and second track segments 106-2 to interact with a second propulsion motor 110 of the vehicle 112 (e.g. at the outward side 308), the second track segments 106-2 located along a second side (e.g. the outward side 308) of the straight rail 402, opposite the first side, the straight rail 402 extending away from the curved rail 404 in opposite directions. The second track segments 106-2 are further following the straight rail 402 in the opposite directions on the second side. The second track segments 106-2 further located such that the second propulsion motor 110 of the vehicle clears the second track segments 106-2 when the vehicle 112 follows the curved rail 404 from the straight rail 402.

It is furthermore understood that a depth of the clearance zone 904 may depend on a turning radius of the vehicle 112, and/or a radius and/or radii of the curved rail 404, and the like. For example, the smaller the turning radius of the vehicle 112, and/or a radius and/or radii of the curved rail 404, and the like, the deeper the clearance zone 904, and similarly, the larger the turning radius of the vehicle 112, and/or a radius and/or radii of the curved rail 404, and the like, the shallower the clearance zone 904.

It is further understood that, while not depicted, the walls 102 are adapted to enclose the curved portion 304 as well as the straight portion 302, for example, with the walls 102 forming respective tubes for each of the curved portions 304. It is further understood that such walls 102 and/or tubes may be adapted to include respective clearance zones similar to the clearance zone 904, and/or such that propulsion motors 110 and/or guidance actuators 120 of a vehicle 112 do not collide with the walls 102.

As has been previously mentioned, the switch 300 may include as few as one curved portion 304, and hence one curved rail 404. However, the switch 300 may further include a plurality of curved rails, curving away from the straight rail 402, including the curved rail 404, each of the plurality of curved rails comprising a respective magnetic gap 420 between the straight rail 402 and a respective curved rail, the plurality of curved rails spaced a distance along the straight rail 402 to enable the vehicle 112 to turn down a first curved rail, of the plurality of curved rails, without interference from a second curved rail, of the plurality of curved rails.

In particular, such curved rails may be spaced apart by distances that may depend on a turning radius of the vehicle 112, and/or a radius and/or radii of the curved rails 404, and the like. For example, as the turning radius of the vehicle 112, and/or a radius and/or radii of the curved rail 404 decreases, the curved rails 404 may be located closer to each other, and, similarly, as the turning radius of the vehicle 112, and/or a radius and/or radii of the curved rail 404 increases, the curved rails 404 may be located further from each other.

As has been previously described, the vehicle 112 generally comprises: a body, such the payload 108 and/or the structure 604; at least one levitation actuator 116 attached to the body, the at least one levitation actuator 116 to interact with a rail 114 that includes a straight rail 402 and a curved rail 404 and a magnetic gap 420 the straight rail 402 and the curved rail 404, the magnetic gap 420 being of lower magnetic permeability relative to the straight rail 402 and the curved rail 404; and at least one guidance actuator 120 to interact with a guidance rail 118 located at a same side of the straight rail 402 from which the curved rail 404 extends, the at least one guidance actuator 120 controllable to guide the body along the straight rail 402 or the curved rail 404. In general, the at least one levitation actuator 116 is further to pull the body away from the curved rail 402 in a region of the magnetic gap 420, for example, to center the body on the straight rail 402. Put another way, the at least one levitation actuator 116 generally maintains a position of the body, relative to the straight rail 402, when the vehicle 112 continues along the straight rail 402 rather than switching to the curved rail 404.

In some examples, the at least one levitation actuator 116 is further to balance guidance forces pulling the body towards the guidance rail 118 and/or the curved guidance rail 414 along the curved rail 404 due to the at least one guidance actuator 120 interacting with the guidance rail 118 (e.g. the curved guidance rail 414) along the curved rail 402.

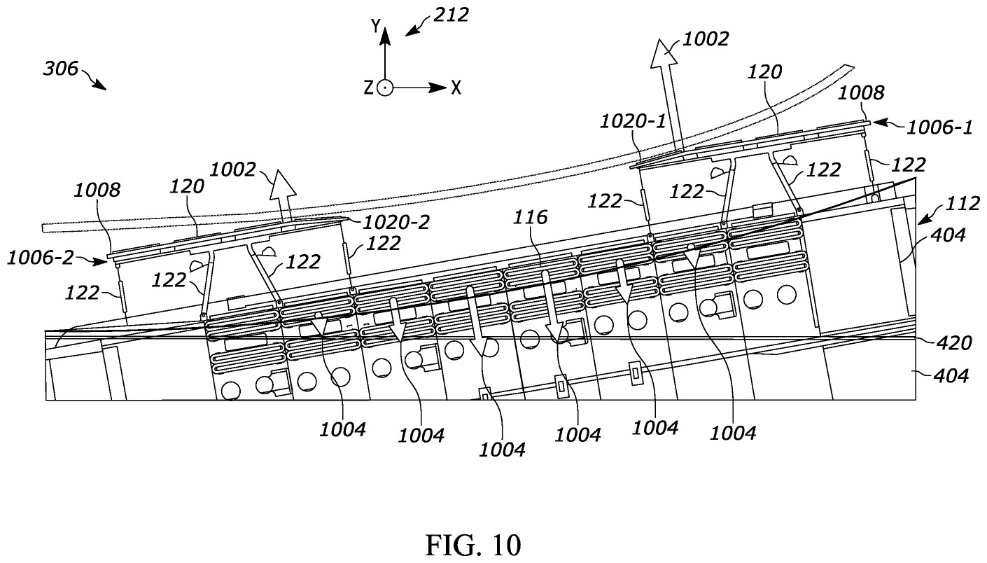

For example, attention is next directed to FIG. 10 which is similar to FIG. 8 but further depicts the guidance actuators 120 of the vehicle 112 interacting with the curved guidance rail 414. In particular, forces 1002 are being generated by the guidance actuators 120 of the vehicle 112 interacting with the curved guidance rail 414 to pull the vehicle 112 towards the curved guidance rail 118 as the vehicle 112 switches to the curved portion 304 and/or the curved rail 404. However, as depicted, such forces 1002 may be of different magnitudes (e.g. as indicated by arrows representing the forces 1002 being of different lengths), which may cause undue stress on the vehicle 112, and may be at least partially balanced by the control system 124 controlling at least portions of the levitation actuators 116 that are outside an inner radius of the curved rail 404 to generate forces 1004 towards the curved rail 404, that may generally oppose the forces 1002. However, it is understood in such examples that the forces 1002 from the guidance actuators 120, and the forces 1004 from the levitation actuators 116, produce a net force towards the curved guidance rail 414 to make the switch from the straight rail 402 to the curved rail 404. However, the levitation actuators 116 may be controlled to reduce the overall stress on the vehicle 112.

Other features are within the scope of the present specification. For example, an edge the outward side 308 or inward side 306 of the straight rail 402 and the curved rail 404 may include features that the vehicle 112 may be configured to communicate with, such as sensors and/the like, and/or read (e.g. via cameras and the like), such as visual indicators, that provide the vehicle 112 with a physical reference for a position of the vehicle 112 within the system 100. Such features may allow the vehicle 122 to encode locations and or actions based on location, so that navigation of the switching regions (e.g. the switch 300 and/or the curved portions 304) may be localized and/or oriented appropriately.

As has hence been described herein, an electromagnetic guidance system may include actuators that interact with components of a track and/or a rail, and may interact with a track component to produce force, such as the guidance actuators 120 interacting with the guidance rails 118. Such an electromagnetic guidance system may comprise a vehicle, such as the vehicle 112, that includes one or more “skis” to which actuators are attached. For example, with attention directed briefly to FIG. 10, vehicle 112 may comprise one or more structures which may be referred to as a ski 1006 (e.g. as depicted there are two skis 1006-1, 1006-2), to which the guidance actuators 120 are understood to be attached, and which may include the struts 122 which attach the guidance actuators 120 to the vehicle 112 and/or the payload 108, as well as a mechanical structure 1008 onto which a plurality of the guidance actuators 120 may be attached, for example in a row relative to the movement axis 117 of the vehicle 112. Put another way, a ski 1006 may comprise of a plurality of electromagnetic actuators such as the guidance actuators 120. In a turn, or during a switching maneuver, an electromagnetic guidance ski 1006 may become tangent to a curved surface, such as the curved rail 414, such that the plurality of electromagnetic actuators are able to produce a balanced force between leading and trailing halves of a ski 1006 with respect to a direction of motion. Put another way, there may be actuators, such the guidance actuators 120, at both a front end and a back end of a ski 1106, and/or any other suitable structure, and which are positioned along a direction of motion for example along the movement axis 117.

One method of positioning actuators at a guidance ski is to fix the actuators with reference to a vehicle (e.g. a chassis thereof), such that the actuators do not move with respect to the vehicle. This configuration may be referred to as a fixed configuration. In such a fixed configuration, the actuators may be positioned such that they have at least one surface which is tangent to a curvature of a track and/or rail which with they are interacting to generate a force, for example to maximize a quantity and/or magnitude of such a force. Since the actuators are fixed in place, however, they may only be positioned to be tangent to one particular radius of track and/or rail curvature.

The electromagnetic guidance system of the present specification may therefore be adapted to place at least one electromagnetic actuator at an angle with respect to the other electromagnetic actuators, such that a ski may comprise electromagnetic actuators which are tangent to at least two radii of track curvature. Electromagnetic guidance skis may be configured to be tangent to multiple radii by positioning at least one actuator at each angle corresponding to an appropriately selected track curvature. The actuators may all be fixed in place. For example, with reference to FIG. 10, it is apparent that a guidance actuator 1020-1 (e.g. one of four guidance actuators 120) attached to the ski 1006-1 is at a different angle than the other three guidance actuators 120 attached to the ski 1006-1; similarly, it is apparent that a guidance actuator 1020-2 (e.g. one of four guidance actuators 120) attached to the ski 1006-2 is at a different angle than the other three guidance actuators 120 attached to the ski 1006-2. The guidance actuators 1020 may be innermost guidance actuators 1020, and/or guidance actuators 1020 closest to a middle of the vehicle 112.

Hereafter, while reference is made to various configurations of vehicles, skis and actuators, and/or electromagnetic actuators, it is understood that such vehicles, skis and actuators may be similar to the vehicle 112, the skis 1106 and the guidance actuators 120, but adapted for functionality as described hereafter. Hence, while propulsion components, such as the propulsion motors 110, and levitation components, such as the levitation actuators 116, are not depicted, they are nonetheless understood to be present. Similarly, while reference is made to various configurations of tracks and/or rails, and in particular guidance rails, it is understood that such tracks and/or rails and/or guidance rails are similar to the components of the system 100 (e.g. the track 104 and the guidance rails 118), as well as components of the switch 300, including, but not limited to the straight rail 412 and the curved rail 414. Similarly, while not all the tracks and/or rails are referred to and/or depicted, hereafter, it is understood that any suitable track segments and/or rails, such as the track segments 106 and the levitation rail 108, they are nonetheless understood to be present.

In some examples it may challenging to position at least one electromagnetic actuator to be tangent to a specific value of a track and/or rail radius. Such a situation may occur when a track and/or rail radius is very small, or when a performance requirement on the guidance system is very high. In one example configuration, a guidance ski may be about 3 meters long, and the value of a track and/or rail radius may be 5 meters. In such an example configuration, the electromagnetic actuators may not be fixed in place with respect to a vehicle chassis and may instead be configured to pivot with respect to a shared axis.

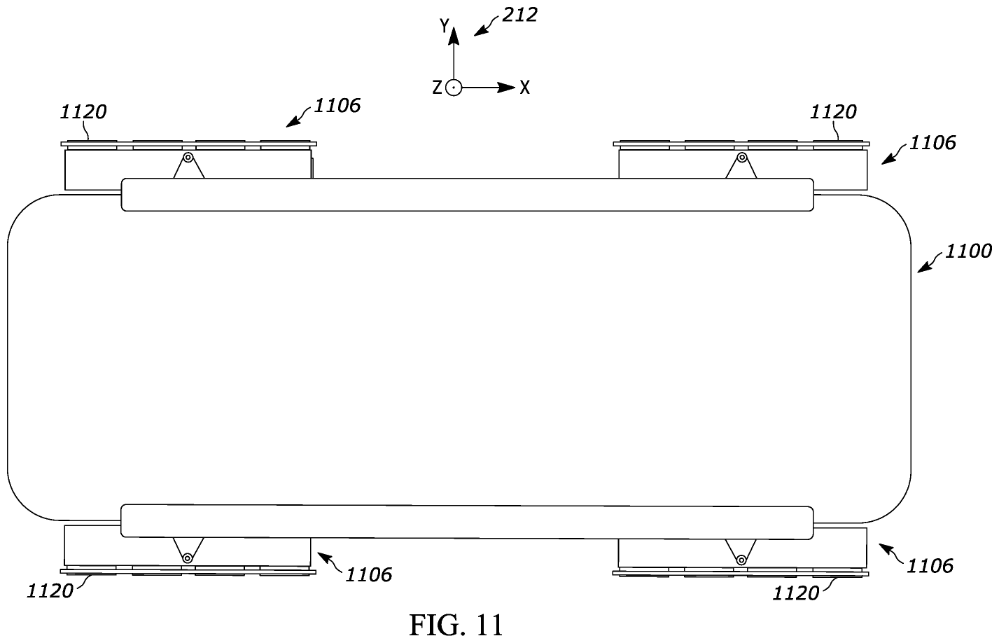

Attention is next directed to FIG. 11, which depicts a vehicle 1100 comprising four guidance skis 1106 with pivoted axes, each ski 1106 comprising four electromagnetic actuators 1120 (e.g. though only one actuator 1120 is indicated per ski 1106). The vehicle 1100 may be similar to the vehicle 112, the skis 1106 may be similar to the skis 1006, and the electromagnetic actuators 1120 may be similar to the guidance actuators 120. From the configuration of FIG. 11, it is apparent that that all four electromagnetic actuators 1120, of each ski 1106, are coplanar, such that all four electromagnetic actuators 1120 may interact with a track and/or rail in one plane. This example configuration may be optimal for interactions with, and/or proximity to, a straight and/or flat track and/or rail, such as the straight rail 412. The electromagnetic actuators 1120 may be referred to as a coplanar series of electromagnetic actuators.

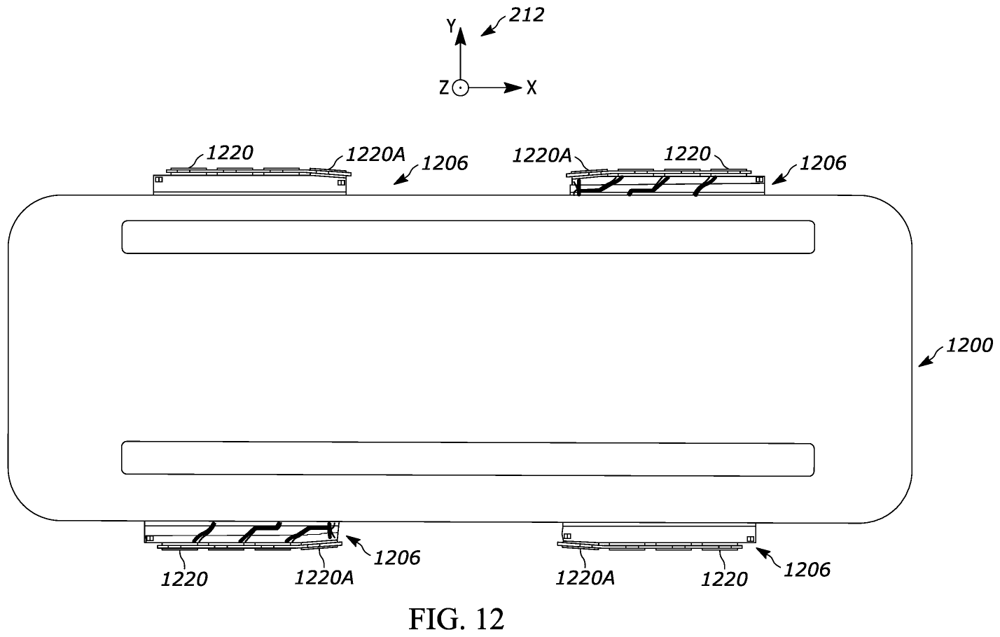

In many examples, however, a track and/or a rail may not be straight and/or flat, such as the curved rail 414. For example, attention is next directed to FIG. 12, which depicts a vehicle 1200 comprising four guidance skis 1206, each ski 1206 comprising four electromagnetic actuators 1220, including respective angled electromagnetic actuators 1220A, which are angled relative to the remaining actuators 1220, and the skis 1206 may be fixed in place (e.g. do not pivot). From the configuration of FIG. 12, it is apparent that three electromagnetic actuators 1220, of each ski 1206, are coplanar, and may be configured to interact with a flat track and/or rail, such as the straight rail 412, and would be positioned about parallel to flat track and/or rail, such as the straight rail 412; however the angled electromagnetic actuators 1220A would be angled (e.g. not parallel) relative a flat track and/or rail, such as the straight rail 412. This configuration is similar to the example of FIG. 10, from which it is apparent that the angled guidance actuators 1020-1, 1020-1 (e.g. which are similar to the angled electromagnetic actuators 1220A) are angled such that they are about parallel to the curved rail 414. Hence, it is understood that an angle of an angled electromagnetic actuators 1220A may be selected such that, when the vehicle 1200 is interacting with a curved track and/or rail, an angled electromagnetic actuators 1220A is about parallel to the curved track and/or rail. As such, an angle of an angled electromagnetic actuators 1220A generally depends on a radius of curvature of a curved track and/or rail with which the angled electromagnetic actuators 1220A is configured to interact. Electromagnetic actuators 1220 of a given ski 1206, excluding the angled actuators 1220A, may be referred to as a coplanar series of electromagnetic actuators.

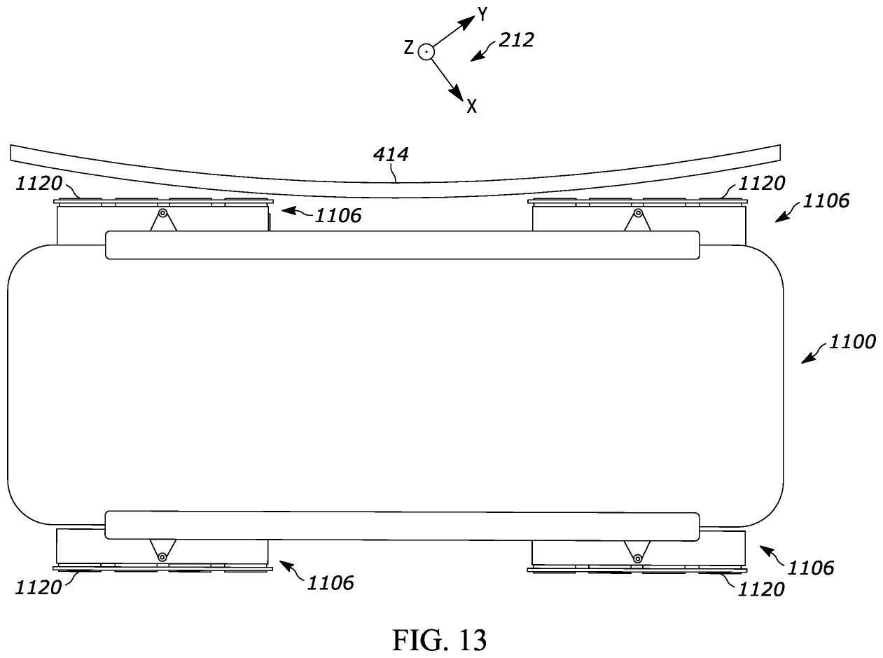

Attention is next directed to FIG. 13 which depicts the vehicle 1100 of FIG. 11 moving relative to the curved rail 414. It is apparent from FIG. 13 that the actuators 1120 at the skis 1106 adjacent the curved rail 414 are not positioned tangent to the curved rail 414 (e.g. none of the actuators 1120 may be tangent to a curved track and/or rail). Hence, this configuration may have poor “force authority” (e.g. an amount of force generated), such that an electromagnetic guidance system represented by the actuators 1120 and the curved rail 414, and the like, may not be able to exert a “large” amount of force on the curved rail 414, and/or any other curved track, and as such the performance of the guidance system may be reduced, for example as compared to when the actuators 1220 of the vehicle 1200 are used, as is next described.

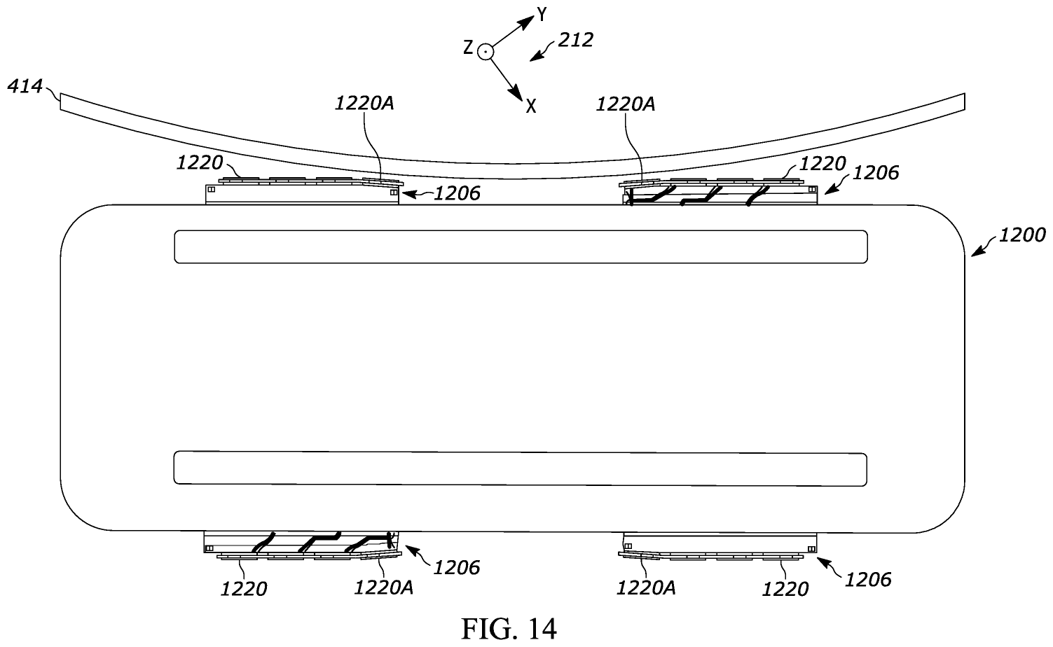

For example, attention is next directed to FIG. 14 which depicts the vehicle 1200 of FIG. 12 moving relative to the curved rail 414. It is apparent from FIG. 14 that angled actuators 1220A at the skis 1206 adjacent the curved rail 414 are positioned tangent to the curved rail 414 (while the other the actuators 1220 are not). Hence, this configuration may have better “force authority” (e.g. an amount of force generated), as compared to the vehicle 1100.

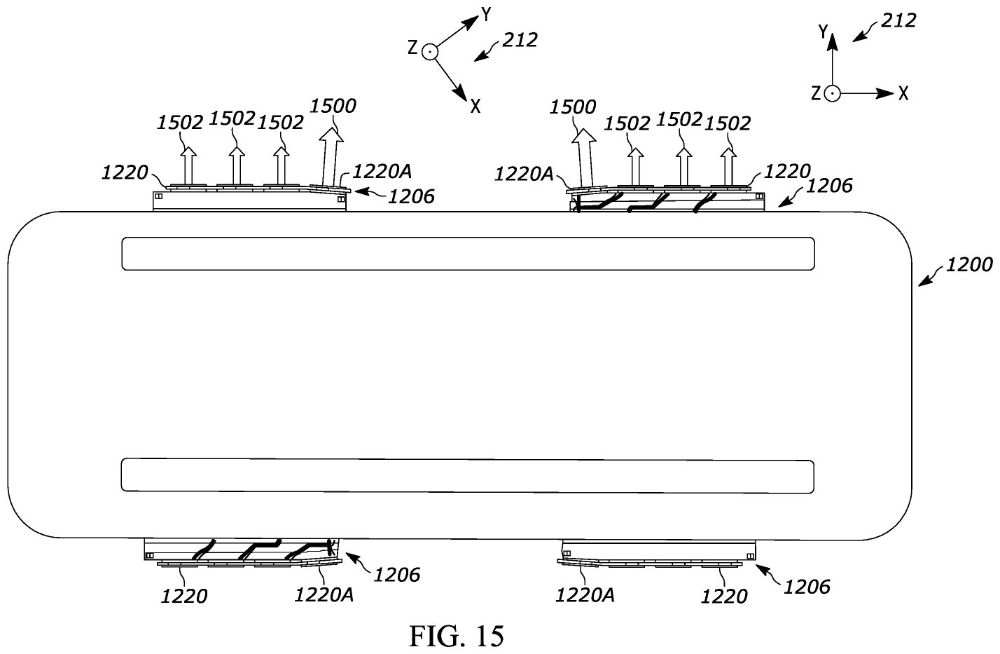

Put another way, at a vehicle comprising a fixed guidance system (e.g. skis do not pivot), an angle of angled electromagnetic actuators may be selected according to a radius of curvature of a curved track and/or curved rail with which the angled electromagnetic actuators interacts to generate a force, such that the angled electromagnetic actuators are tangent to a track and/or rail when the radius of curvature decreases (e.g. from the straight rail 412 to the curved rail 414). Put another way, when a track and/or rail curves, the angled guidance actuators may become tangent to a curved portion of the track and/or rail, such that angled guidance actuators may have improved force authority (e.g. relative to when a vehicle does not include angled guidance actuators). Example force authority of the fixed guidance skis 1206, that include the angled guidance actuators 1220A, is depicted in FIG. 15, which depicts forces 1500, 1502 generated by the guidance actuators 1220, including the angled guidance actuators 1220A of skis 1206 adjacent the curved rail 414; while the curved rail 414 is not depicted for simplicity, it is understood that the vehicle 1200 in FIG. 15 is positioned relative to the curved rail 414 as depicted in FIG. 14, and that the forces 1500, 1502 are generated by the guidance actuators 1220, including the angled guidance actuators 122A interacting with the curved rail 414. In particular, the forces 1500 generated by the angled guidance actuators 1220A are higher than the forces 1502 generated by the other guidance actuators 1220, and that the forces 1502 decrease the further away a guidance actuator 1220 is from the curved rail 414.

Put another way, the force authority of the angled electromagnetic actuators 1220A is higher than the force authority of a coplanar series of electromagnetic actuators 1220 as the coplanar series of electromagnetic actuators 1220 are not tangent to the curved rail 414.

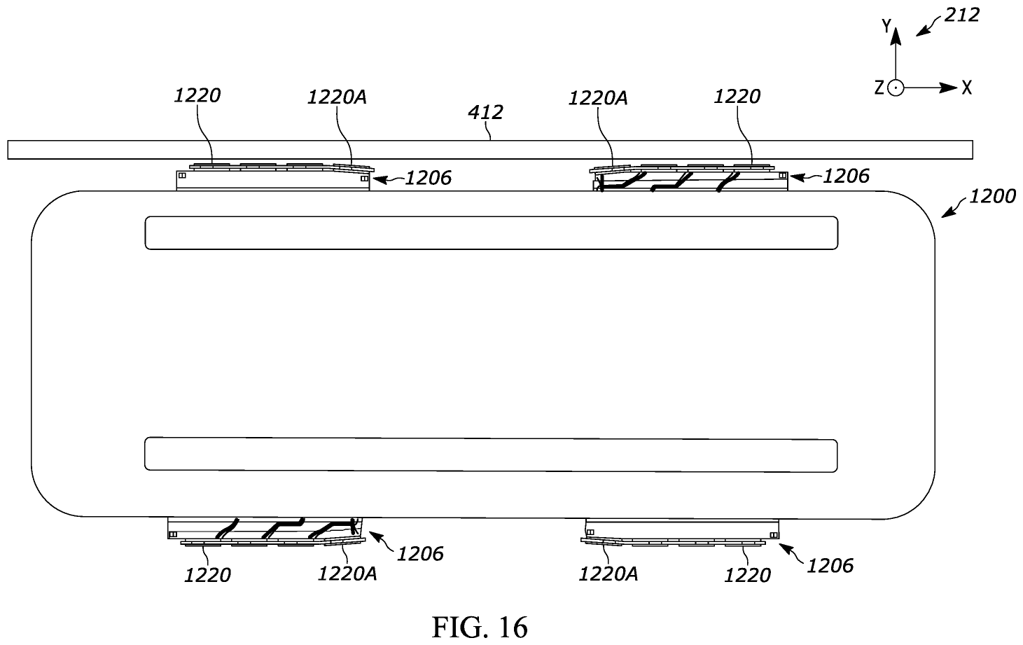

Attention is next directed to FIG. 16 which depicts the vehicle 1200 of FIG. 12 moving relative to the straight rail 412. It is apparent from FIG. 16 that angled actuators 1220A at the skis 1206 adjacent the straight rail 412 are not positioned tangent to the straight rail 412, while the other actuators 1220 are positioned tangent to the straight rail 412 and/or the other actuators 1220 are positioned tangent to the straight rail 412 are parallel to the straight rail 412.

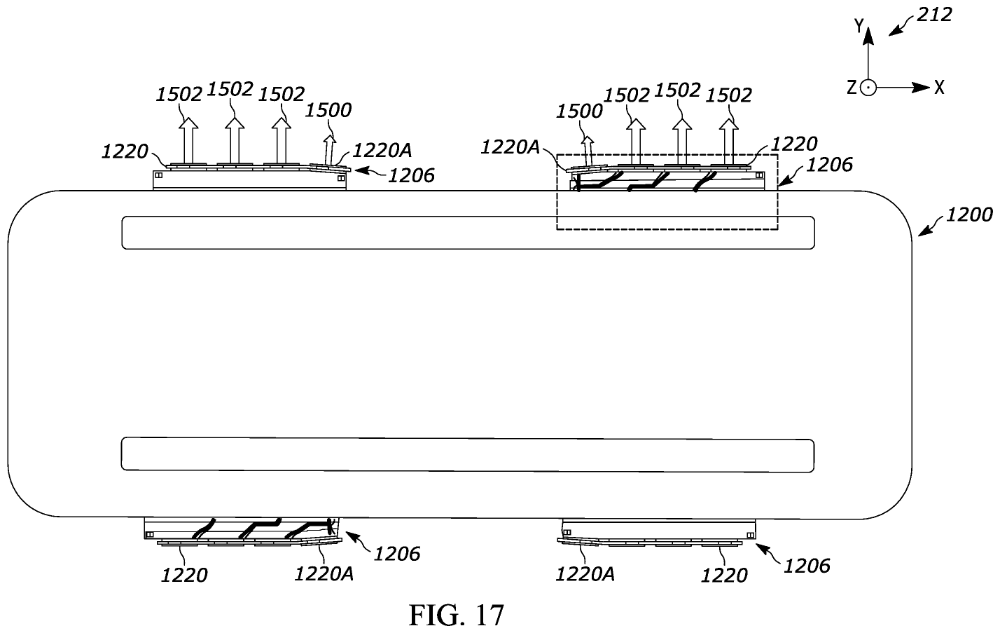

FIG. 17 depicts the force authority of such the example of FIG. 16.

In particular, FIG. 17, which depicts forces 1700, 1702 generated by the guidance actuators 1220, including the angled guidance actuators 122A of skis 1206 adjacent the straight rail 412; while the straight rail 412 is not depicted for simplicity, it is understood that the vehicle 1200 in FIG. 17 is positioned relative to the straight rail 412 as depicted in FIG. 16, and that the forces 1700, 1702 are generated by the guidance actuators 1220, including the angled guidance actuators 122A interacting with the straight rail 412. In particular, the forces 1700 generated by the angled guidance actuators 1220A are lower than the forces 1702 generated by the other guidance actuators 1220, as the angled guidance actuators 1220A are not tangent to the straight rail 412, while the other guidance actuators 1220 are tangent to the straight rail 412.

Put another way, electromagnetic actuators 1220 on skis 1206 which are tangent to a flat and/or straight track, and/or a flat and/or straight rail, may have higher force authority than the electromagnetic actuators 1220A which are not tangent to a flat and/or straight track, and/or a flat and/or straight rail.

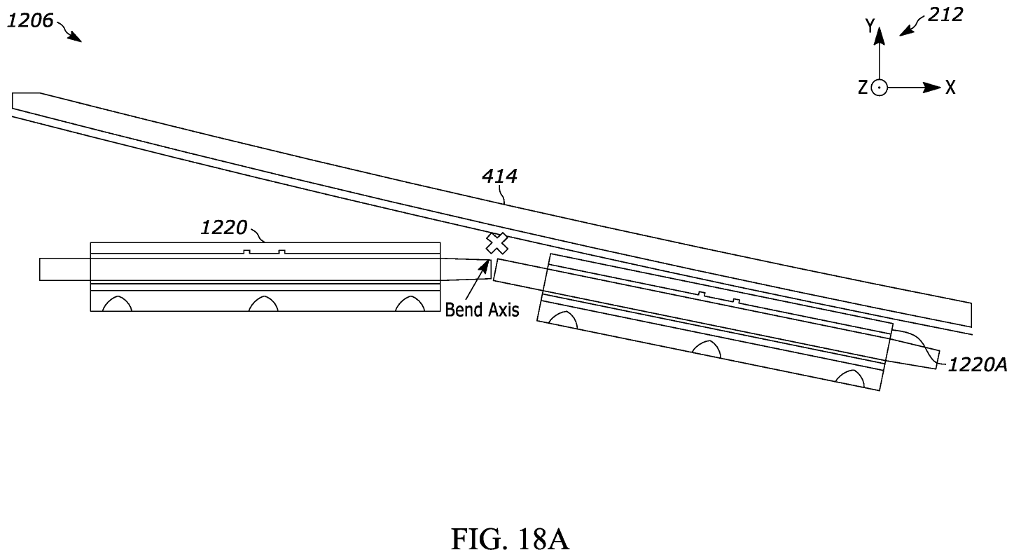

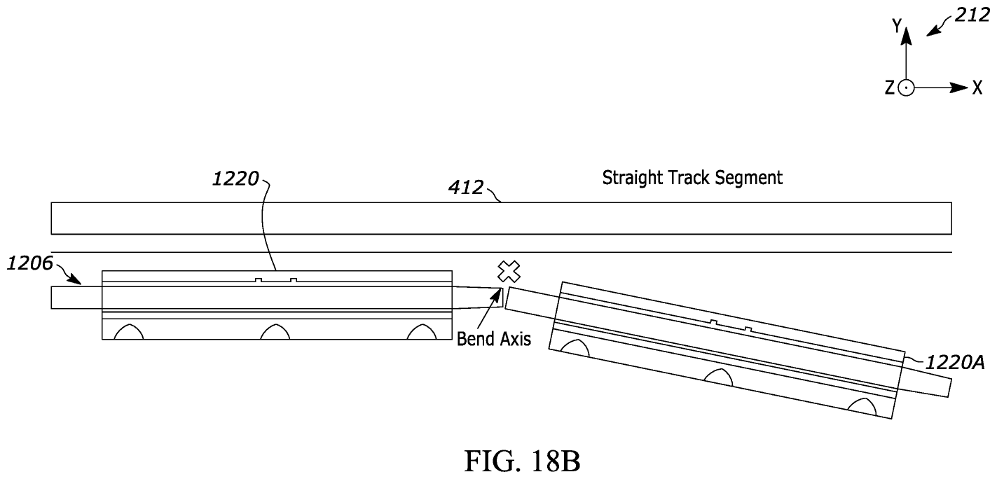

A detailed view of two configurations of a section of a guidance ski 1206 is shown in FIG. 18A and FIG. 18B that includes an electromagnetic actuator 1220 and an angled electromagnetic actuator 1220A. While not depicted, it is understood that the electromagnetic actuator 1220 depicted in FIG. 18A and FIG. 18B is one of a coplanar series of electromagnetic actuators. A bend axis between the angled electromagnetic actuator 1220A and the coplanar series of electromagnetic actuators 1220 is also depicted (e.g. an axis at which a bend and/or angle occurs between the angled electromagnetic actuator 1220A and the coplanar series of electromagnetic actuators 1220).

In FIG. 18A, the electromagnetic actuator 1220 and the angled electromagnetic actuator 1220A are shown in proximity to the curved rail 414, where the angled electromagnetic actuator 1220A is tangent to the curved rail 414, and the other electromagnetic actuator 1220 is not tangent to the curved rail 414 (e.g. and neither are the other electromagnetic actuators 1220).

In FIG. 18B, the electromagnetic actuator 1220 and the angled electromagnetic actuator 1220A are shown in proximity to the straight rail 412, where the electromagnetic actuator 1220 is about tangent to the curved rail 414 (e.g. as are the other electromagnetic actuators 1220), and the angled electromagnetic actuator 1220A is not tangent to the straight rail 412.

As has already been described with respect to FIG. 15, which has a configuration similar to that of FIG. 18A, and FIG. 17, which has a configuration similar to that of FIG. 18B, the angled guidance actuator 1220A has a high force authority compared to the force authority of the coplanar series of actuators 1220 in the configuration of FIG. 18A; and the angled guidance actuator 1220A has a low force authority compared to the force authority of the coplanar series of actuators 1220 in the configuration of FIG. 18B.

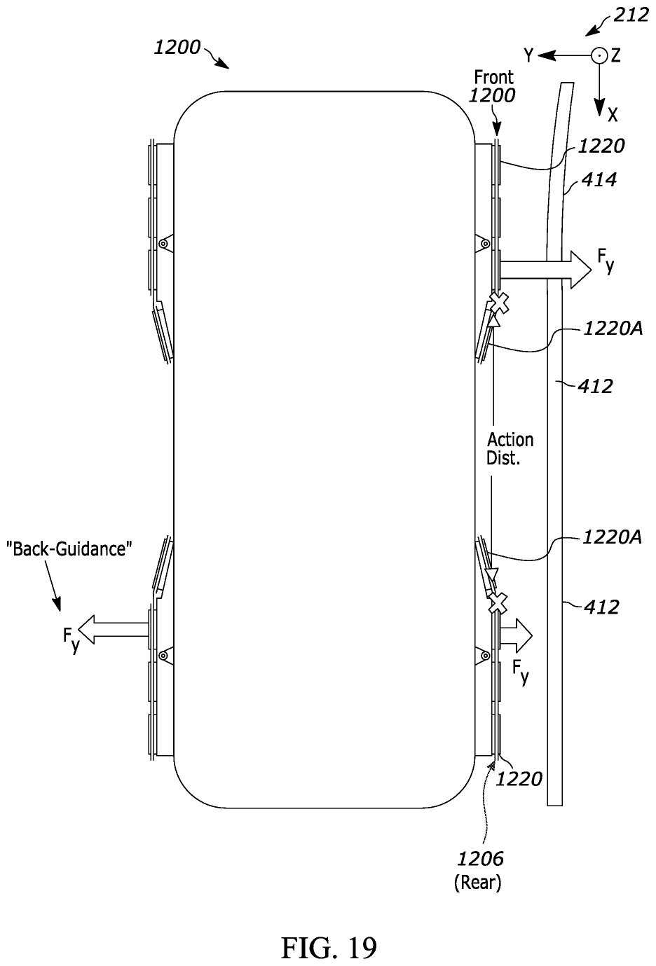

When the guidance system described herein is used to navigate a curved section of a track and/or rail, which is adjacent to a straight section of a track and/or rail (e.g. as when controlling the vehicle 1200 to switch from the straight portion 302 to the curved portion 304), it may be important to carefully control the forces exerted by electromagnetic actuators. Such a track section is shown in FIG. 19, which depicts the vehicle 1200 switching using forces generated by the electromagnetic actuators 1220, 1220A interacting with the straight rail 412 and the curved rail 414 (e.g. to control the vehicle 1200 to switch from the straight portion 302 to the curved portion 304). In particular, as depicted, the vehicle 1200 is located relative to the rail 412 and the curved rail 414 such that a coplanar series of actuators 1220 of a front ski 1206 are adjacent (and not tangent to) the curved rail 414, while the angled actuator 1220A of the front ski 1206 is still adjacent (and not tangent to) the straight rail 412. However, a coplanar series of actuators 1220 of a rear ski 1206 are adjacent (and tangent to) the straight rail 412, while the angled actuator 1220A of the rear ski 1206 is adjacent (and not tangent to) the straight rail 412.

The guidance system may exert a yawing force to cause the vehicle 1220 to rotate and follow the curvature of the curved rail 414 as the vehicle 1220 moves. A distance between a centroid of a force, Fy of each ski 1206 forces is labelled as the Action Distance (e.g. “Action Dist.”). This distance may define two parameters—an angle of a guidance ski 1206 that will produce tangency at that particular action distance, and an amount at which a back side of the vehicle 1200 will swing past its previous position along a lateral axis defined by the motion of the vehicle 1200 and a plane of the track and/or rail curvature.

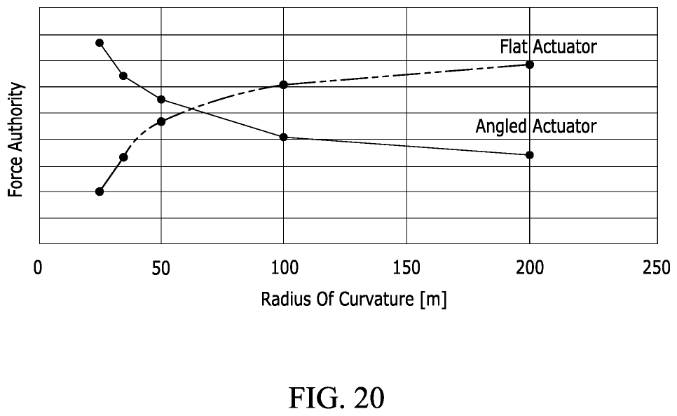

The force authority of the electromagnetic actuators 1220, 1220A may be dependent on the curvature of the track and/or rail, and on a degree of tangency that the electromagnetic actuators 1220, 1220A have with respect to the track and/or rail. As shown in FIG. 20, increasing radius of curvature is correlated with increasing force authority for the flat or coplanar series of actuators 1220, and with decreasing force authority for the angled actuators 1220A. In other words, a flatter track and/or rail with a larger radius will be closer to tangency with the coplanar series of actuators 1220.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

Persons skilled in the art will appreciate that there are yet more alternative examples and modifications possible, and that the above examples are only illustrations of one or more examples. The scope, therefore, is only to be limited by the claims appended hereto.

What is claimed is:

1. A switch for a levitation rail for a vehicle, the switch comprising:
a straight rail;
a curved rail, curving away from the straight rail, the straight rail and the curved rail comprising magnetic material to magnetically interact with a motor of the vehicle; and
a magnetic gap between the straight rail and the curved rail, the magnetic gap comprising a region, at which the straight rail and the curved rail meet, of lower magnetic permeability relative to the straight rail and the curved rail.

2. The switch of claim 1, wherein the magnetic gap comprises one or more of a non-magnetic material and air.

3. The switch of claim 1, wherein the magnetic gap comprises one or more of a groove and a slot between the straight rail and the curved rail.

4. The switch of claim 1, further comprising:
a guidance rail located along a same side of the straight rail from which the curved rail extends, the guidance rail further following an inner radius of the curved rail, such that the guidance rail curves away the straight rail in the region of the magnetic gap, the guidance rail to interact with a first guidance actuator of the vehicle,
wherein no corresponding guidance rail is located at an opposite side of the straight rail and the curved rail such that a second guidance actuator of the vehicle, opposite the first guidance actuator, is inoperative in the region of the magnetic gap.

5. The switch of claim 4, further comprising walls within which the straight rail, the curved rail and the guidance rail are located, the walls located such that the second guidance actuator of the vehicle clears the walls at the opposite side of the straight rail and the curved rail when the vehicle follows the curved rail from the straight rail.

6. The switch of claim 1, further comprising:
A guidance rail located along a same side of the straight rail from which the curved rail extends, the guidance rail further following an inner radius of the curved rail, such that the guidance rail curves away the straight rail in the region of the magnetic gap, the guidance rail to interact with a first guidance actuator of the vehicle to switch the vehicle to the curved rail.

7. The switch of claim 1, wherein the straight rail comprises a primary portion of a levitation rail, the straight rail extending away from the curved rail in opposite directions, and the curved rail is towards a station for the vehicle.

8. The switch of claim 1, further comprising:
first track segments to interact with a propulsion motor of the vehicle, the first track segments located along a first side of the straight rail from which the curved rail extends, the first track segments further following an inner radius of the curved rail; and
second track segments to interact with the propulsion motor of the vehicle, the second track segments located along a second side of the straight rail, opposite the first side, the straight rail extending away from the curved rail in opposite directions, the second track segments further following the straight rail in the opposite directions on the second side.

9. The switch of claim 1, further comprising:
a plurality of curved rails, curving away from the straight rail, including the curved rail, each of the plurality of curved rails comprising a respective magnetic gap between the straight rail and a respective curved rail, the plurality of curved rails spaced a distance along the straight rail to enable the vehicle to turn down a first curved rail, of the plurality of curved rails, without interference from a second curved rail, of the plurality of curved rails.

10. A vehicle comprising:
a body;
at least one levitation actuator attached to the body, the at least one levitation actuator to interact with a rail that includes a straight rail and a curved rail and a magnetic gap between the straight rail and the curved rail, the magnetic gap being of lower magnetic permeability relative to the straight rail and the curved rail; and
at least one guidance actuator to interact with a guidance rail located at a same side of the straight rail from which the curved rail extends, the at least one guidance actuator controllable to guide the body along the straight rail or the curved rail.

11. The vehicle of claim 10, wherein the at least one levitation actuator is further to balance guidance forces pulling the body towards the guidance rail along the curved rail due to the at least one guidance actuator interacting with the guidance rail along the curved rail.

12. An electromagnetic guidance system comprising:
at least one rail; and
a vehicle comprising at least one ski and one or more electromagnetic actuators attached to the at least one ski, such that a force is generated between the at least one electromagnetic actuator and the at least one rail;
wherein:
the rail is one or more of flat, curved, and twisted; and
the one or more electromagnetic actuators are positioned such that the one or more electromagnetic actuators are tangent to tightly curved rail surfaces, minimally curved rail surfaces, and straight rail surfaces.

13. The electromagnetic guidance system of claim 12, further comprising a sequence of actuators which have coplanar poles, including the one or more electromagnetic actuators, and at least one angled actuator disposed at an angle to other actuators.

14. The electromagnetic guidance system of claim 13, wherein the at least one angled actuator is fixed at an angle such that the at least one angled actuator remains tangent to a tightly curved rail.

15. The electromagnetic guidance system of claim 13, wherein the at least one angled actuator is movably positioned with respect to the sequence of actuators.

16. The electromagnetic guidance system of claim 12, further comprising a sequence of actuators, including the one or more electromagnetic actuators, which have coplanar poles, wherein all of the actuators are movably positionable as a group.

17. The electromagnetic guidance system of claim 16, wherein the sequence of actuators are movably positionable using a pivoted mechanical structure.

18. The electromagnetic guidance system of claim 17, wherein the sequence of actuators are positionable using a force generated by the sequence of actuators interacting with the at least one rail.

19. The electromagnetic guidance system of claim 17, wherein the sequence of actuators are positionable using an active mechanism.

20. The electromagnetic guidance system of claim 17, wherein the sequence of actuators are positionable using a passive system.
